(19) United States
(12) Patent Application Publication
(10) Pub. No.: US 2010/0181909 A1
(43) Pub. Date: Jul. 22, 2010

(54) PLASMA DISPLAY PANEL

(76) Inventors: Takuji Tsujita, Osaka (JP); Yusuke Fukui, Osaka (JP); Masaharu Terauchi, Hyogo (JP); Mikihiko Nishitani, Nara (JP); Shinichiro Ishino, Shiga (JP); Kaname Mizokami, Kyoto (JP); Michiko Okafuji, Osaka (JP); Hiroshi Asano, Osaka (JP); Kyohei Yoshino, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/665,310

(22) PCT Filed: Apr. 15, 2008
(86) PCT No.: PCT/JP2008/000986

§ 371 Date: Dec. 17, 2009

(30) Foreign Application Priority Data
Jul. 13, 2007 (JP) 2007-184220

(51) Int. Cl. H01J 17/49

(52) U.S. Cl. 313/585

(57) ABSTRACT

A plasma display panel demonstrating excellent image display performance by suppressing generation of initialization bright points through modification of the phosphor layer, and by eliminating variation in discharge characteristics between the discharge cells of each color. In addition to solving these problems, the luminance of the plasma display panel is also enhanced by using the ultraviolet rays emitted in the discharge space in order to promote the production of visible light on the front panel side. Specifically, the phosphor layer (14) is composed of a phosphor component and of MgO powder (16) disposed principally inside the phosphor layer and exposed towards the surface (140) facing the discharge space in order to impart secondary electron emission characteristics. The MgO powder (16) is composed of MgO particles (16a-16d) having a crystal structure with two specific crystal faces consisting of the (100) crystal face and the (111) crystal face, or three specific crystal faces consisting of the (100) crystal face, the (110) crystal face, and the (111) crystal face.

### TECHNICAL FIELD

The present invention relates to plasma display panels used in a variety of displays and a production method therefor.

### BACKGROUND ART

In recent years, starting with “high vision” or HD-TV, expectations for high definition, high quality, large screen televisions continue to rise, and plasma display panels (hereinafter referred to as PDPs) have attracted attention as a color display device that can be large, yet thin and lightweight.

FIG. 16 is a schematic view showing the structure of a discharge cell, or a discharge unit, of a general AC PDP. The PDP 1x shown in FIG. 16 is constituted by a front panel 2 and a back panel 9 that are assembled together. The front panel 2 includes a front panel glass 3. A plurality of display electrode pairs 6, each composed of a scan electrode 5 and a sustain electrode 4, are disposed on one surface of the front panel glass 3. A dielectric layer 7 and a surface layer 8 are layered sequentially to cover the display electrode pairs 6. The scan electrode 5 and the sustain electrode 4 are respectively composed of transparent electrodes 51 and 41 and bus lines 52 and 42 layered thereon.

The dielectric layer 7 is made of low-melting glass with a softening point of approximately 550° C.-600° C. and has a current limiting function that is peculiar to the AC PDP.

The surface layer 8 protects the dielectric layer 7 and the display electrode pairs 6 from ion bombardment as a result of plasma discharge produced in the discharge space 15 upon driving of the PDP. The surface layer 8 also efficiently emits secondary electrons in the discharge space 15 and lowers firing voltage. Generally, the surface layer 8 is formed with magnesium oxide (MgO) material that has high secondary electron emission characteristics, high sputtering resistance, and high optical transparency to a thickness of approximately 0.5-1 μm using the vacuum deposition method or the printing method. Note that a protective layer that has an identical structure to the surface layer 8 may be established as a protective layer to ensure the secondary electron emission characteristics, in addition to protecting the dielectric layer 7 and the display electrode pairs 6.

On the other hand, a back panel 9 includes a back panel glass 10 and a plurality of data (address) electrodes 11, which are used for writing image data, disposed thereon so as to intersect the display electrode pairs 6 at a right angle. On the back panel glass 10, a dielectric layer 12 made of low-melting glass is disposed to cover the data electrodes 11. Disposed on the dielectric layer 12, at the border with the neighboring discharge cell (not illustrated), are barrier ribs 13 of a given height, made of low-melting glass. The barrier ribs 13 are composed of pattern parts 1231 and 1232 that are combined to form a grid pattern to partition a discharge space 15. Phosphor ink containing phosphor material of either a red (R), green (G), or blue (B) color is applied to the surface of the dielectric layer 12 and the lateral surfaces of the barrier ribs 13, and baked to form phosphor layers 14 (phosphor layers 14R, 14G, and 143).

The front panel 2 and the back panel 9 are sealed together around the edges of both panels such that the display electrode pairs 6 are orthogonal to the data electrodes 11 in the discharge space 15. In the sealed discharge space 15, a rare gas mixture such as xenon-neon or xenon-helium is enclosed as a discharge gas at some tens of kilopascals. This concludes a description of the structure of the PDP 1x.

A gradation expression method (e.g. an intra-field time division grayscale display method) that divides one field of an image into a plurality of subfields (S.F.) is used as a driving method for the PDP 1x.

A conventional PDP has the following problems.

The first problem is the generation of initializing bright points.

In conventional PDPs, for each initialization period, in order to initialize all of the display cells and improve the contrast ratio, a small, weak electrical discharge called a weak discharge (initialization discharge) needs to be carried out stably. For this reason, PDPs usually have a ramp waveform impressed between the scan electrode on the front panel and the data electrode on the back panel. Along the ramp waveform, the change in voltage-time fluctuates on a gradual slant. By steadily running a small discharge current, the weak discharges can be stabilized.

However, in the discharge at the time of impression of the up ramp waveform during the initialization period, either the data electrode along the back panel or the phosphor side with a small secondary electron emission coefficient is the cathode, and thus the firing voltage can easily become high. This can sometimes cause production of the weak discharge to become unstable, and a strong discharge may be produced. A strong discharge becomes an erroneous light emission (initializing bright point) unrelated to the image and appears on the screen as an undesirable bright point, isolated or in a line. This causes image display performance to decrease dramatically.

As a way to improve the luminance of a PDP, the density of Xe in the discharge gas composition is sometimes increased. However, the problem with an increased density of Xe is that it can contribute to production of initializing bright points.

The second problem is that the discharge cell for each color in the PDP can cause variations in each other's secondary electron emission characteristics.

In other words, in conventional PDPs, phosphor material for either red (R), green (G), or blue (B) is used in each color's phosphor layer; as this material differs in composition by color, discharge cells of different colors have varying discharge characteristics because of the secondary electron emission characteristics of each phosphor material. These variations can adversely affect the display characteristics of the entire panel, and thus this is a problem that needs to be addressed.

The third problem is that when driving the PDP, a portion of the vacuum ultraviolet light produced by the discharge gas is absorbed in the MgO layer, making it difficult to improve luminance.

In other words, in a PDP with a protective layer made of MgO, when the PDP is driven, the 147 nm or 173 nm vacuum ultraviolet light produced by the Ne—Xe or other discharge gas is emitted in the discharge space as a spherical wave. In this sort of spherical wave, the vacuum ultraviolet light that reaches the phosphor layer disposed on the back panel is accompanied by a visible light emission caused by the phosphor component in the phosphor layer.

Using vacuum ultraviolet light not radiated towards the phosphor layer to contribute to production of visible light would promote efficient production of visible light, and could be expected to improve luminance. However, in the protective layer that widely faces the discharge space on the front panel side, vacuum ultraviolet light is absorbed with almost no relation to the phosphor layer. As a result, the problem exists that the vacuum ultraviolet light radiated towards the front panel side effectively cannot contribute to visible light in the phosphor layer.

An attempt has been made to reduce the occurrence of initializing bright points by adhering a particulate powder to the phosphor layer, the powder having a secondary electron emission coefficient γ higher than the phosphor material composing the phosphor layer (see Patent Document 1 identified below). An attempt has also been made to improve luminance by applying MgO particles formed by the gas-phase oxidation method to the dielectric layer or to the MgO film formed by the vacuum deposition method, sputtering method, etc. The phosphor layer is then made to emit visible light with the ultraviolet light emitted by the MgO particles (see Patent Document 2 identified below).

Patent Document 1: WO 06/038654.

Patent Document 2: Japanese Patent Application Publication No. 2006-59786.

### DISCLOSURE OF THE INVENTION

### The Problems the Invention is Going to Solve

It is difficult to say, however, that the occurrence of initializing bright points has actually been successfully suppressed in any of the afore-mentioned prior art, and this is a difficult problem to solve effectively.

While suppressing the occurrence of initializing bright points, for a PDP to have superior image display performance it is also important to improve luminance and to eliminate variation of discharge characteristics between each color's discharge cells, yet this is considered to be extremely difficult.

Thus, state-of-the-art PDPs still have room for improvement.

The present invention is conceived in view of the above problems, and it is a first object of the present invention to provide a plasma display panel with superior image display performance and a production method therefor, improving the quality of the phosphor layer and suppressing the occurrence of initializing bright points, while also eliminating variation of discharge characteristics between each color's discharge cells.

In addition to solving the above-mentioned problems, it is a second object of the present invention to provide a plasma display panel with improved luminance and a production method therefor, using the ultraviolet light emitted in the discharge space on the front panel side to promote emission of visible light.

### Means to Solve the Problems

To solve the above problems, the present invention provides a plasma display panel having a first substrate and a second substrate that oppose each other with a discharge space therebetween and are sealed together around edge portions thereof, the first substrate including a phosphor layer in a surface region thereof facing the discharge space, wherein the phosphor layer includes a phosphor component and MgO powder containing MgO particles that each have a crystal structure with a (100) crystal face and a (111) crystal face, and the MgO powder is disposed at one or more of the following: (i) inside the phosphor layer, (ii) on a surface of the phosphor layer facing the discharge space, or (iii) on a bottom of the phosphor layer facing a back side of the first substrate.

In the above-stated plasma display panel, a surface region of the second substrate facing the discharge space may have MgO powder containing MgO particles with a crystal structure identical to the crystal structure of the MgO particles in the phosphor layer.

In the above-stated plasma display panel, the surface region of the second substrate may have a plurality of electrodes and a dielectric layer covering the plurality of electrodes, and the MgO powder located in the surface region of the second substrate maybe disposed on a surface of the dielectric layer either directly or with a protective layer therebetween.

In the above-stated plasma display panel, the MgO particles may have a hexahedral structure, with at least one truncated surface. In this case, a main surface of the MgO particles may be the (100) crystal face, and the truncated surface may be the (ill) crystal face.

The above-stated MgO particles may have an octahedral structure, with at least one truncated surface. In this case, a main surface of the MgO particles may be the (111) crystal face, and the truncated surface may be the (100) crystal face.

The above-stated MgO particles may be tetrakaidecahedral, having 14 surfaces, of which six surfaces are the (100) crystal face, and eight surfaces are the (111) crystal face. In this case, the main surface of the MgO particles may be the (100) crystal face, and a truncated surface may be the (111) crystal face, or the main surface of the MgO particles may be the (111) crystal face, and a truncated surface may be the (100) crystal face.

Furthermore, the present invention provides a plasma display panel having a first substrate and a second substrate that oppose each other with a discharge space therebetween and are sealed together around edge portions thereof, the first substrate including a phosphor layer in a surface region thereof facing the discharge space, wherein the phosphor layer includes a phosphor component and MgO powder containing MgO particles that each have a crystal structure with a (100) crystal face, a (110) crystal face, and a (111) crystal face, and the MgO powder is disposed at one or more of the following: (i) inside the phosphor layer, (ii) on a surface of the phosphor layer facing the discharge space, or (iii) on a bottom of the phosphor layer facing a back side of the first substrate.

In the above-stated plasma display panel, a surface region of the second substrate facing the discharge space may have MgO powder containing MgO particles with a crystal structure identical to the crystal structure of the MgO particles in the phosphor layer.

In the above-stated plasma display panel, the surface region of the second substrate may have a plurality of electrodes and a dielectric layer covering the plurality of electrodes, and the MgO powder located in the surface region of the second substrate may be disposed on a surface of the dielectric layer either directly or with a protective layer therebetween.

The above-stated MgO particles may have a hexahedral structure, with at least one truncated surface and at least one oblique surface. In this case, a main surface of the MgO particles may be the (100) crystal face, the truncated surface may be the (111) crystal face, and the oblique surface may be the (100) crystal face.

The above-stated MgO particles may have an octahedral structure, with at least one truncated surface and at least one oblique surface. In this case, a main surface of the MgO particles may be the (111) crystal face, the truncated surface may be the (100) crystal face, and the oblique surface maybe the (110) crystal face.

The above-stated MgO particles may be hexaicosahedral, having 26 surfaces, of which six surfaces are the (100) crystal face, 12 surfaces are the (110) crystal face, and eight surfaces are the (111) crystal face. In this case, a main surface of the MgO particles may be the (111) crystal face, an oblique surface may be the (110) crystal face, and a truncated surface may be the (100) crystal face, or a main surface of the MgO particles may be the (100) crystal face, an oblique surface may be the (110) crystal face, and a truncated surface may be the (111) crystal face.

The MgO particles in the present invention are preferably a product of MgO precursor baking. The MgO particles have a preferred diameter of 300 nm or greater. Furthermore, the MgO particles have an ideal BET value of 2.0 m²/g or smaller.

### EFFECTS OF THE INVENTION

As the PDP in the present invention with the above structure is driven, when ultraviolet rays produced in the discharge space reach the phosphor layer, MgO particles receive the ultraviolet rays and demonstrate, excellent secondary electron emission characteristics. The MgO particles have specific crystal faces and are packed in the gap between the phosphor particles. In this way, during the initialization period, abundant secondary electrons are released from the phosphor layer into the discharge space, and the weak discharge proceeds smoothly. This creates an ideal weak discharge and makes it possible to suppress the occurrence of an undesirable strong discharge (initializing bright point).

The MgO particles in the present invention also emit ultraviolet rays during a discharge. Thus, in addition to the ultraviolet rays emitted in the discharge space, the phosphors are also excited by the ultraviolet rays emitted by the MgO particles in the phosphor layer, making it possible to produce visible light efficiently. In the phosphor layer, the MgO particles that surround the phosphor particles make it possible efficiently to excite the phosphor particles from their surroundings. They also make it possible to prevent diffuse reflection and reflect visible light appropriately, thereby promising emission of visible light at a high degree of luminance.

Furthermore, the MgO particles in the present invention have sufficiently high secondary electron emission characteristics as compared to the phosphors, and therefore by disposing these MgO particles on the phosphor layer, it is possible to make the variations in discharge characteristics, caused by each phosphor component in the phosphor layer of each color, relatively small. As a result, it is possible to make the discharge characteristics uniform between each color's discharge cell throughout the PDP, making for stable image display performance.

By also disposing MgO powder on the front panel (second substrate) in the present invention, the phosphors in the phosphor layer are not only directly excited by the spherical wave of ultraviolet rays emitted in the discharge space, but also receive the ultraviolet rays emitted by the MgO particles on the back panel and the front panel, as these MgO particles themselves are excited by the emitted spherical wave of ultraviolet rays. Thus, the phosphors are excited even more efficiently. As a result, abundant visible light is emitted in the phosphor layer, resulting in very bright, high quality image display performance.

In the explanation of the MgO powder in the present invention, the MgO powder was said to “include” MgO particles with specific crystal faces, which means that the MgO powder also contains MgO particles with a crystal structure other than the above-mentioned MgO particles. It is considered that as the proportion of the present invention's MgO particles in the MgO powder increases, so do the effects of the present invention.

### BRIEF DESCRIPTION OF THE DRAWINGS

FIG. 1 is a cross-sectional view showing the structure of a PDP in accordance with Embodiment 1 of the present invention.

FIG. 2 is a schematic view showing a relation between electrodes and drivers.

FIG. 3 shows an example waveform when the PDP is driven.

FIGS. 4A, 4B, 4C and 4D are views each showing the shape of each MgO particle.

FIGS. 5A, 5B, 5C, 5D, 5E and 5F are views showing variations of the shape of each MgO particle.

FIGS. 6A, 6B, 6C and 6D show photographs of the shape of each MgO particle.

FIG. 7 is a graph showing the relationship between the emission wavelength and the emission intensity of MgO particles.

FIG. 8 is a graph showing waveforms obtained by observing the MgO particles by cathodoluminescence measurement.

FIG. 9 is a graph showing the relationship between frequency and the BET value of an MgO particle.

FIG. 10 is a cross-sectional view showing the structure of a PDP in accordance with Embodiment 2 of the present invention.

FIG. 11 is a cross-sectional view showing the structure of a PDP in accordance with Embodiment 3 of the present invention.

FIG. 12 is a cross-sectional view showing the structure of a PDP in accordance with Embodiment 4 of the present invention.

FIG. 13 is a graph showing the relationship between the weight density of MgO in the entire phosphor layer and luminance.

FIG. 14 is a graph showing whether or not initializing bright points occur in the Example and Comparative Example PDPs.

FIG. 15 is a graph showing the luminance of the Example and Comparative Example PDPs.

FIG. 16 is a cross-sectional view showing the structure of a conventional PDP.

### DESCRIPTION OF CHARACTERS

1, 1a, 1b, 1c, 1x PDP

2 front panel

3 front panel glass

4 sustain electrode

5 scan electrode

6 display electrode pair

7, 12 dielectric layer

8 surface layer

9 back panel

10 back panel glass

11 data (address) electrode

13 barrier rib

14 phosphor layer

15 discharge space

16, 16X, 16Y MgO powder

16a MgO particle having two specific crystal faces

16b MgO particle having two specific crystal faces

16c MgO particle having three specific crystal faces

16d MgO particle having three specific crystal faces

16a1, 16a2 variation of MgO particle having two specific crystal faces

16b1, 16b2 variation of MgO particle having two specific crystal faces

16c1 variation of MgO particle having three specific crystal faces

16d1 variation of MgO particle having three specific crystal faces

17 protective layer

140 surface of phosphor layer

### BEST MODE FOR CARRYING OUT THE INVENTION

The following describes preferred embodiments and examples of the present invention. Note that the present invention is never limited to these, and various changes may be made as necessary without departing from the technical scope of the present invention.

### Embodiment 1

### (Structure of PDP)

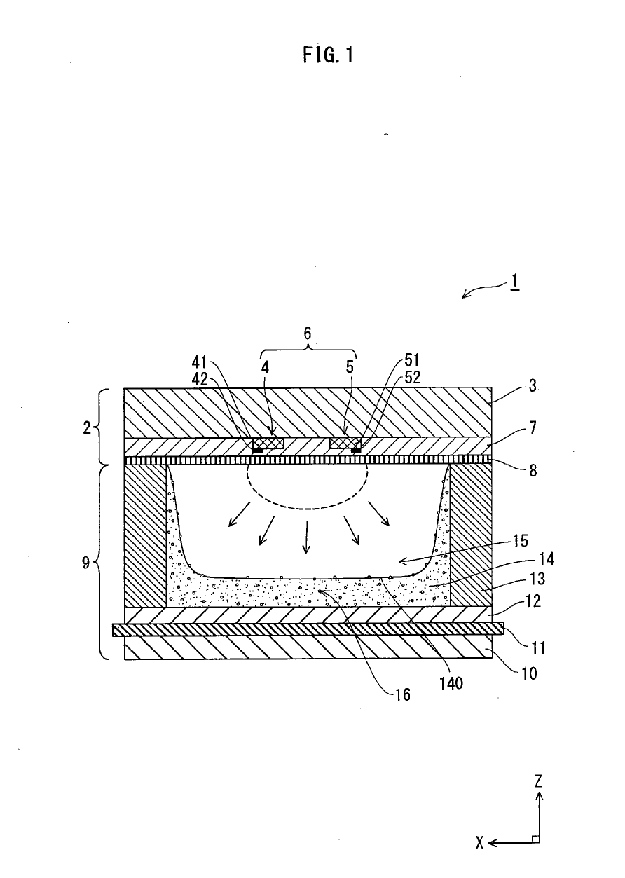

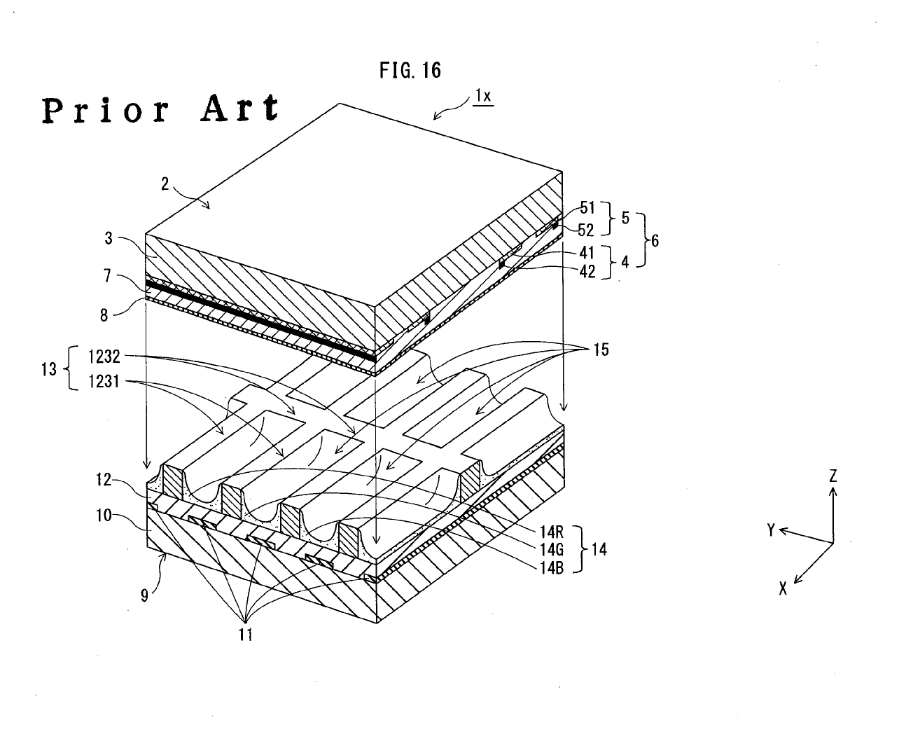

FIG. 1 is a schematic sectional view along the x-z plane of the PDP 1 in accordance with Embodiment 1 of the present invention. The structure of the PDP 1 is similar to that of a conventional PDP (FIG. 16) except for the structure in the vicinity of the protective layer.

Note that for the sake of explanation, the particle diameter of the MgO powder 16 disposed on the inside of the phosphor layer 14 has been represented larger than actual size and schematically.

The PDP 1 is an AC PDP with a 42-inch screen in conformity with NTSC specification. The present invention may be, of course, applied to other specifications such as XGA and SXGA. The applicable specifications of a high-definition PDP able to display images at an HD (high-definition) resolution or higher are PDPs with a panel size of 37, 42, and 50 inches having 1024×720 (pixels), 1024×768 (pixels), and 1366×768 (pixels), respectively. In addition, a panel with an even higher resolution than these HD panels may also be used. Examples of a PDP having a higher definition than HD PDP include a full HD PDP with a resolution of 1920×1080 (pixels).

As shown in FIG. 1, the PDP 1 is substantially composed of two members: a first substrate (back panel 9) and a second substrate (front panel 2) that oppose each other in face-to-face relationship.

The front panel 2 includes a front panel glass 3 as its substrate. On one main surface of the front panel glass 3, a plurality of electrode pairs 6 (each composed of a scan electrode 5 and a sustain electrode 4) are each disposed with a given discharge gap (75 μm) in-between. Each electrode pair 6 is composed of a transparent electrode 51 or 41 and a bus line 52 or 42 layered thereon. Transparent electrodes 51 and 41 (0.1 μm thick, 150 μm wide) are disposed in a strip made of transparent conductive materials such as indium tin oxide (ITO), zinc oxide (ZnO), and tin oxide (SnO₂). The bus lines 52 and 42 (7 μm thick, 95 μm wide) are made of an Ag thick film (2 μm-10 μm thick), an Al thin film (0.1 μm-1 μm thick), a Cr/Cu/Cr layered thin film (0.1 μm-1 μm thick) or the like. These bus lines 52 and 42 reduce the sheet resistance of the transparent electrodes 51 and 41.

The term “thick film” refers to a film that is formed by various kinds of thick-film forming methods. In thick-film forming methods, a film is formed by applying a paste or the like containing conductive materials and then baking the paste. The term “thin film” refers to a film that is formed by various kinds of thin-film processing using vacuum processing such as a sputtering method, ion plating method, or electron-beam deposition method.

On the entire main surface of the front panel glass 3 where the display electrode pairs 6 are disposed, a dielectric layer 7 is formed with use of a screen printing method or other method. The dielectric layer 7 is made of low-melting glass (35 μm thick) that contains lead oxide (PbO), bismuth oxide (Bi₂O₃) or phosphorus oxide (PO₄) as the principal component.

The dielectric layer 7 has a current limiting function that is peculiar to the AC PDP, which. is why the AC PDP can last longer than the DC PDP.

On the surface of the dielectric layer 7 that faces the discharge space 15, the surface layer 8 is disposed. The surface layer 8 is a thin film applied for the purpose of protecting the dielectric layer 7 from ion bombardment at the time of discharge and lowering the firing voltage. The surface layer 8 is formed with MgO material that has high sputtering resistance and a high secondary electron emission coefficient γ, and is formed on top of the dielectric layer 7 to approximately a 1 μm thickness by a commonly known thin film forming method, such as the vacuum deposition method, ion plating method, etc. The material for the surface layer 8 is not limited to MgO, and can also be made by including at least one metal oxide chosen from among the group of MgO, CaO, Bao, and SrO.

On one main surface of the back panel glass 10 that is the substrate of the back panel 9, data electrodes 11 each with a width of 100 μm are formed in a stripe pattern having a fixed gap (360 μm) therebetween. The data electrodes 11 are adjacent to each other in the y direction, and each extends in the x direction longitudinally. The data electrodes 11 are made up of any one of an Ag thick film (2 μm-10 μm thick), an Al thin film (0.1 μm-1 μm thick), a Cr/Cu/Cr layered thin film (0.1 μm-1 μm thick), or the like. The dielectric layer 12 with a thickness of 30 μm is disposed on the entire surface of the back panel glass 9 to enclose the data electrodes 11.

On the dielectric layer 12, the grid-shaped barrier ribs 13 (approximately 110 μm high and 40 μm wide) are each disposed above the gap between the adjacent data electrodes 11. The barrier ribs 13 prevent erroneous discharge or optical crosstalk by partitioning the discharge cells.

On the lateral surfaces of two adjacent barrier ribs 13 and on the surface of the dielectric layer 12 between the lateral surfaces, a phosphor layer 14 corresponding to either red (R), green (G) or blue (B) color is formed for color display. The composition of each kind of phosphor is as follows: for blue phosphors (B), BAM:Eu; for red phosphors (R), (Y, Gd) BO₃: Eu or Y₂O₃:EU, etc.; for green phosphors (G), Zn₂SiO₄:Mn, YBO₃:Tb, (Y, Gd) BO₃:Tb, etc., all of which are well-known.

The phosphor layer 14 includes the above-mentioned phosphor component and an MgO powder 16, disposed principally inside the phosphor layer and exposed towards the surface 140 facing the discharge space 15 in order to impart secondary electron emission characteristics. One characteristic of Embodiment 1 is that the MgO powder 16 includes MgO particles 16a-16d, each having a crystal structure with either two specific crystal faces formed by faces (100) and (111), or three specific crystal faces, formed by faces (100), (110), and (111). Details about the MgO particles 16a-16d are described later.

Note that the dielectric layer 12 is nonessential and that the phosphor layer 14 may directly cover the data electrodes 11.

The front panel 2 and the back panel 9 are disposed with a space in-between such that the data electrodes 11 and the display electrode pairs 6 are orthogonal to each other in plan view. The edge portions around the panels 2 and 9 are sealed with glass frit. In the space between the panels 2 and 9, a discharge gas composed of inert gases such as He, Xe and Ne is enclosed at a given pressure.

Between the barrier ribs 13 is a discharge space 15. Where the adjacent display electrode pair 6 intersects a data electrode 11 via the discharge space 15 corresponds to a discharge cell (also referred to as a “sub-pixel”) that functions to display images. The discharge cell pitch is 675 μm in the x direction and 300 μm in the y direction. Three adjacent discharge cells whose colors are red, green and blue compose one pixel (675 μm×900 μm).

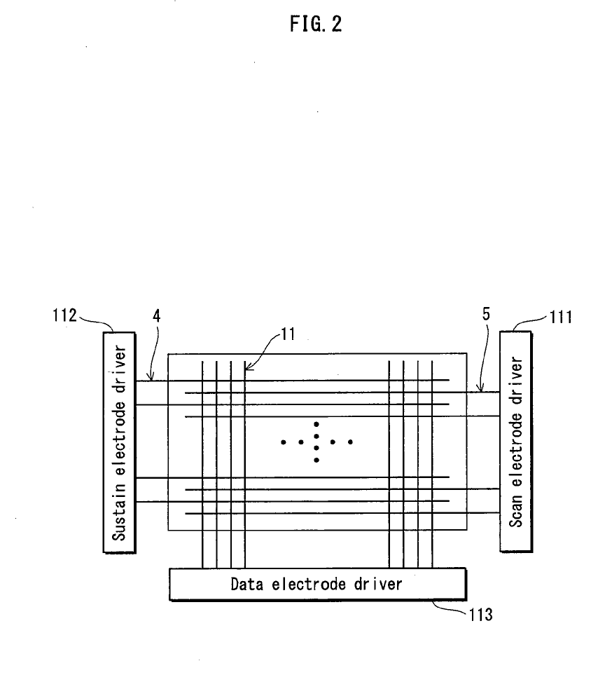

As shown in FIG. 2, near the edges of the panel in the x and y directions, the scan electrodes 5, the sustain electrodes 4 and the data electrodes 11 are respectively connected to a scan electrode driver 111, a sustain electrode driver 112 and a data electrode driver 113 that are included in a driving circuit. The sustain electrodes 4 are connected to the sustain electrode driver 112 collectively, whereas each scan electrode 5 and data electrode 11 is connected respectively to the scan electrode driver 111 or the data electrode driver 113 independently.

### (Driving of PDP)

As soon as the PDP 1 with the above structure is driven, a heretofore-known driving circuit (not shown) including the drivers 111-113 applies an AC voltage ranging from tens to hundreds of kilohertz between the display electrode pairs 6 to generate discharge in selectable discharge cells. As a result, ultraviolet rays (shown as the dotted lines and the arrows in FIG. 1) including resonance lines with wavelengths of mainly 147 nm emitted by the excited Xe atoms and molecular lines with wavelengths of mainly 173 nm emitted by the excited Xe molecules irradiate the phosphor layers 14. Accordingly, the phosphor layers 14 are excited to emit visible light. The visible light then penetrates the front panel 2 and radiates forward.

As an example of the driving, the intra-field time division grayscale display method is adopted. This method divides one field of an image into a plurality of subfields (S.F.), and further divides each subfield into a plurality of periods. One subfield is divided into four periods: (1) an initialization period in which all discharge cells are reset, (2) an address period in which discharge cells are selectively addressed for display according to input data, (3) a sustain period in which a sustain discharge is generated in the discharge cells that are addressed to display the images, and (4) an erase period in which wall charges generated by the sustain discharge are erased.

In each subfield, the following occurs so that the PDP 1 emits light to display an image. In the initialization period, an initialization pulse resets wall charges in all discharge cells of the entire panel. In the address period, an address discharge is generated in the discharge cells that are intended to light. Subsequently in the sustain period, an AC voltage (sustain voltage) is applied to all the discharge cells simultaneously. Thus, the sustain discharge is generated in the given length of time so as to display the image.

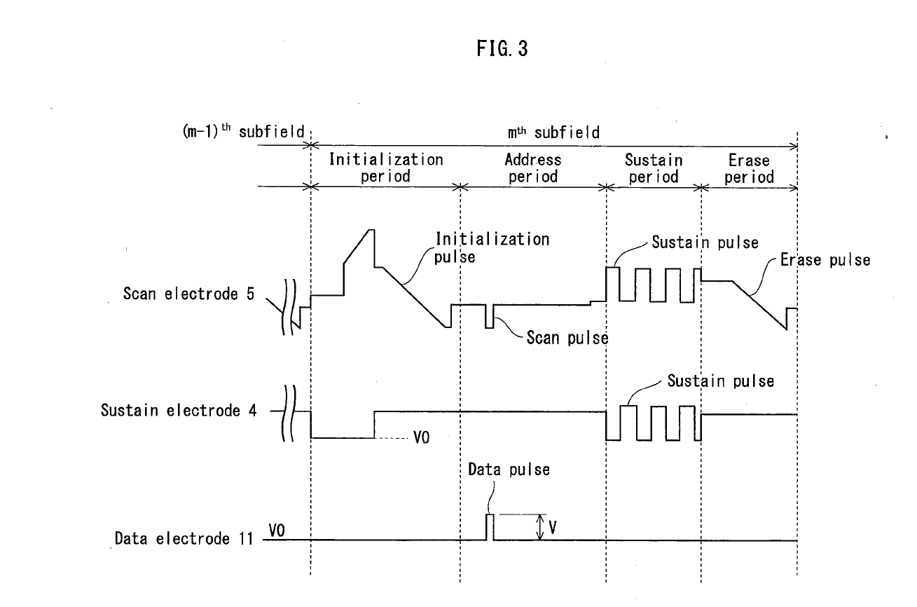

FIG. 3 shows an example of driving waveforms in the m^{th} subfield of one field when the PDP is driven. As shown in FIG. 3, each subfield is divided into the initialization period, the address period, the sustain period and the erase period.

The initialization period is set for erasing the wall charges in all the discharge cells (initialization discharge) so as not to be influenced by the discharge generated prior to the m^{th} subfield (influence of the accumulated wall charges). In the example of the driving waveforms in FIG. 3, a higher voltage (initialization pulse) is applied to the scan electrode 5 than the data electrode 11 and the sustain electrode 4 to cause the gas in the discharge cell to discharge. As a result, electric charges generated by the discharge are accumulated on the wall surface of the discharge cells in order to nullify the potential difference among the data electrodes 11, the scan electrodes 5 and the sustain electrodes 4. Therefore, on the surface of the surface layer 8 around the scan electrodes 5 and on the surface of the MgO powder 16, negative charges are accumulated as wall charges. On the other hand, positive wall charges are accumulated on the surface of the phosphor layers 14 around the data electrodes 11 and on the surfaces of the surface layer 8 and the MgO powder 16 around the sustain electrodes 4. These wall charges cause a given value of wall potential between the scan 5 and data 11 electrodes as well as between the scan 5 and sustain 4 electrodes.

The address period (write period) is for addressing the discharge cells that are selected according to image signals divided into subfields (specifying the discharge cells to light or not). In this period, a lower voltage (scan pulse) is applied to the scan electrodes 5 than to the data electrodes 11 or the sustain electrodes 4 in order to light the intended discharge cells. Specifically, a data pulse is applied between the scan 5 and data 11 electrodes in the same polar direction as the wall potential, as well as between the scan 5 and sustain 4 electrodes in the same polar direction as the wall potential, and thus, the address discharge is generated. As a result, negative charges are accumulated on the surface of the phosphor layers 14, on the surface of the surface layer 8 around the sustain electrodes 4, and on the surface of the MgO powder 16, whereas positive charges are accumulated as wall charges on the surface of the surface layer 8 around the scan electrodes 5 and on the surface of the MgO powder 16. Thus, a given value of the wall potential between the sustain 4 and scan 5 electrodes is generated.

The sustain period is set to sustain the discharge by extending the lighting period of each discharge cell specified by the address discharge so as to keep luminance according to a gradation level. In this period, in the discharge cells that have the wall charges, a sustain discharge voltage pulse (e.g. a rectangular waveform pulse of approximately 200 V) is applied to each electrode in a pair of a scan electrode 5 and a sustain electrode 4, such that the pulses are out of phase with each other. Thus, a sustain pulse discharge is generated in the addressed discharge cells every time when the polarities reverse at the electrodes.

Due to the sustain discharge, in the discharge space 15, resonance lines having wavelengths of 147 nm are emitted from the excited Xe atoms, and molecular lines of 173 nm are emitted from the excited Xe molecules. Thus, these resonance lines and molecular lines are radiated to the surface of the phosphor layers 14 and converted into visible light, and the image is displayed on the screen. The ON-OFF combinations of the subfields of red, green and blue colors enable an image to be displayed in multiple colors and gradations. Note that in the discharge cells in which the wall charges are not accumulated on the surface layer 8, the sustain discharge is not generated, and the discharge cells display black images.

In the erase period, an erase pulse of a declining waveform is applied to the scan electrodes 5, which erases the wall charges.

### (Structure of the MgO Powder)

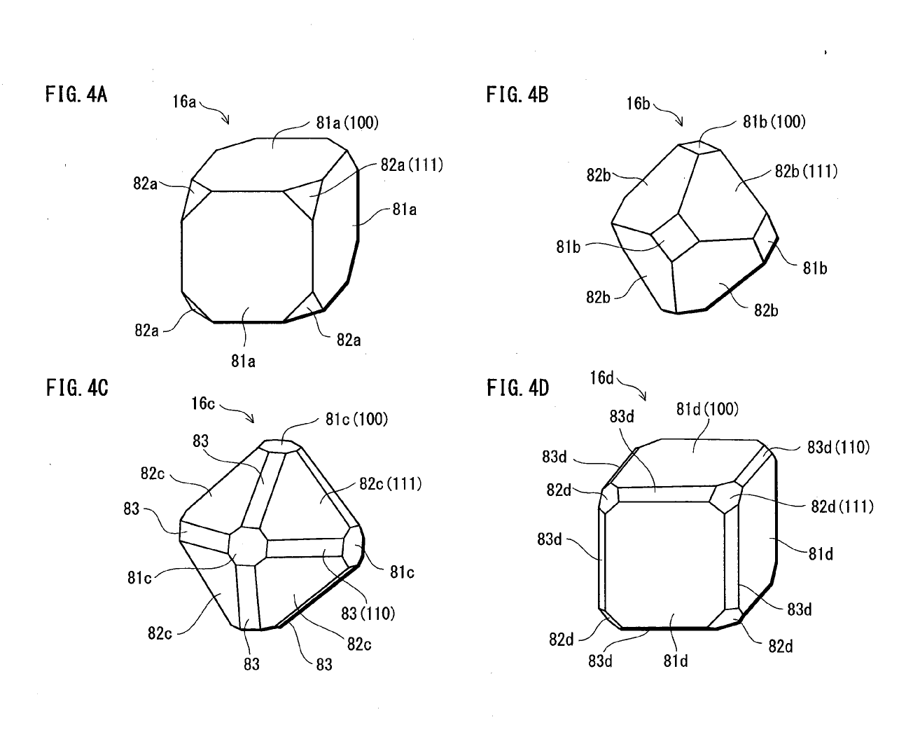

FIGS. 4A-4D show schematic views of the structure of each MgO particle in the MgO powder 16. The MgO powder 16 is formed by baking the MgO precursor and mainly contains four shapes of particles, 16a, 16b, 16c, and 16d.

As shown in FIGS. 4A and 43, the MgO particles 16a and 16b each have an NaCl type crystal structure with two specific crystal faces, face (100) and face (111).

As shown in FIGS. 4C and 4D, the MgO particles 16c and 16d each have an NaCl type crystal structure with three specific crystal faces, face (100), face (110), and face (111).

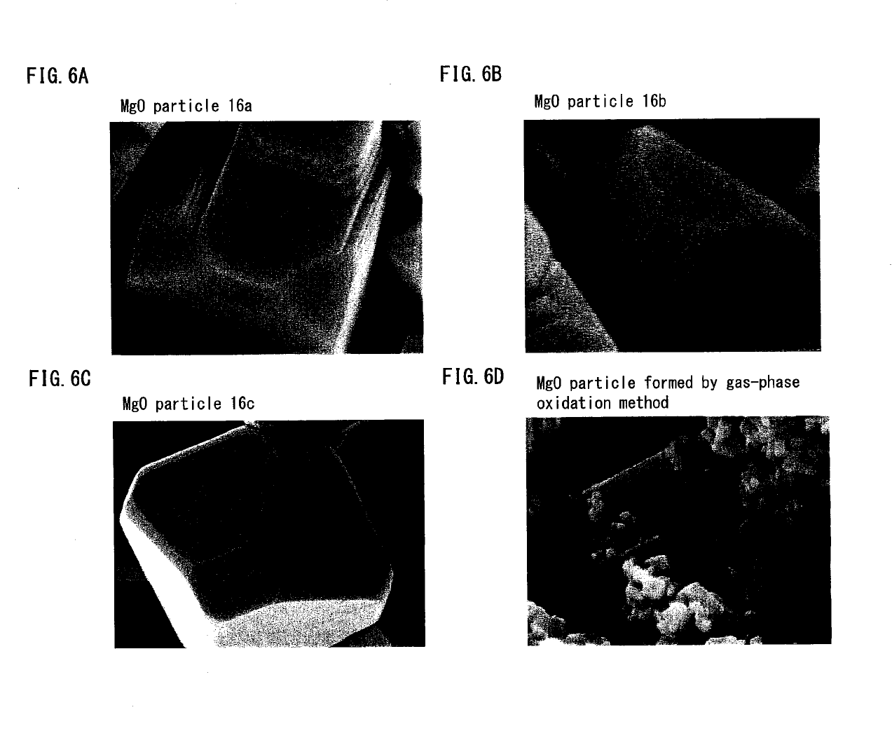

FIGS. 6A-6D are electron micrographs sequentially shoving the shape of each MgO particle 16a, 16b, 16c, and, as a conventional example, an MgO particle formed by the gas-phase oxidation method. As can be seen in FIGS. 6A-6D, the shape of each particle 16a, 16b, 16c, and 16d shown in FIGS. 4A-4D is merely an example, and in reality, some particles are slightly distorted as compared to the shapes in FIGS. 4A-4D.

The basic crystal structure of the MgO particle 16a shown in FIG. 4A is hexahedral. Since the vertexes of the hexahedral structure are truncated, the MgO particle 16a is tetrakaidecahedral (having 14 surfaces) with truncated surfaces 82a. Each main surface 81a which is in an octagonal shape is the (100) crystal face. Each truncated surface 82a which is in a triangular shape is the (111) crystal face. The MgO particle 16a has six main surfaces 81a and eight truncated surfaces 82a.

The basic crystal structure of the MgO particle 16b shown in FIG. 4B is octahedral. Since the vertexes of the octahedral structure are truncated, the MgO particle 16b is tetrakaidecahedral with truncated surfaces 81b. Each main surface 82b in a hexagon shape is the (111) crystal face. Each truncated surface 81b in a quadrangular shape is the (100) crystal face. The MgO particle 16b has eight main surfaces 82b and six truncated surfaces 81b.

In this embodiment, the main surface is, out of the six surfaces or the eight surfaces, a surface that constitutes the largest surface area with the same Miller index. The truncated surface is a surface that is formed by truncating the vertexes of the polyhedral crystal structure.

In this embodiment, as shown in FIG. 4, a ratio of the (100) crystal face to the total surface area of the MgO particle 16a ranges between 50% and 98%, inclusive, whereas that of the MgO particle 16b ranges between 30% and 50%, inclusive.

The MgO particle 16c shown in FIG. 4C is hexaicosahedral (having 26 surfaces). The MgO particle 16c has a basically identical crystal structure to that of the MgO particle 16b except for the following. Each border area between the adjacent truncated surfaces 81c is truncated, and thus an oblique surface 83c is formed on the border area. Hence, the MgO particle 16c is a hexaicosahedron having six hexagonal truncated surfaces 81c each of which is the (100) crystal face, eight octahedral main surfaces 82c each of which is the (111) crystal face, and twelve quadrilateral oblique surfaces 83c each of which is the (110) crystal face.

The MgO particle 16d shown in FIG. 4D is hexaicosahedral. The MgO particle 16d has a basically identical crystal structure to that of the MgO particle 16a except for the following. Each border area between the adjacent main surfaces 81d is truncated, and the truncated area is called an oblique surface 83d. Hence, the MgO particle 16d is a hexaicosahedron having six octahedral main surfaces 81d each of which is the (100) crystal face, eight hexagonal truncated surfaces 82d each of which is the (111) crystal face, and twelve quadrangular oblique surfaces 83d each of which is the (110) crystal face. Note that the surface area of the (100) or (110) crystal face can increase according to a baking condition, and that in such a case, the (100) or (110) crystal face becomes the main surface.

Each oblique surface in this embodiment is a surface that is formed by truncating each side of the main surfaces 82c or 81d that connects two of the truncated surfaces 81c or 82d.

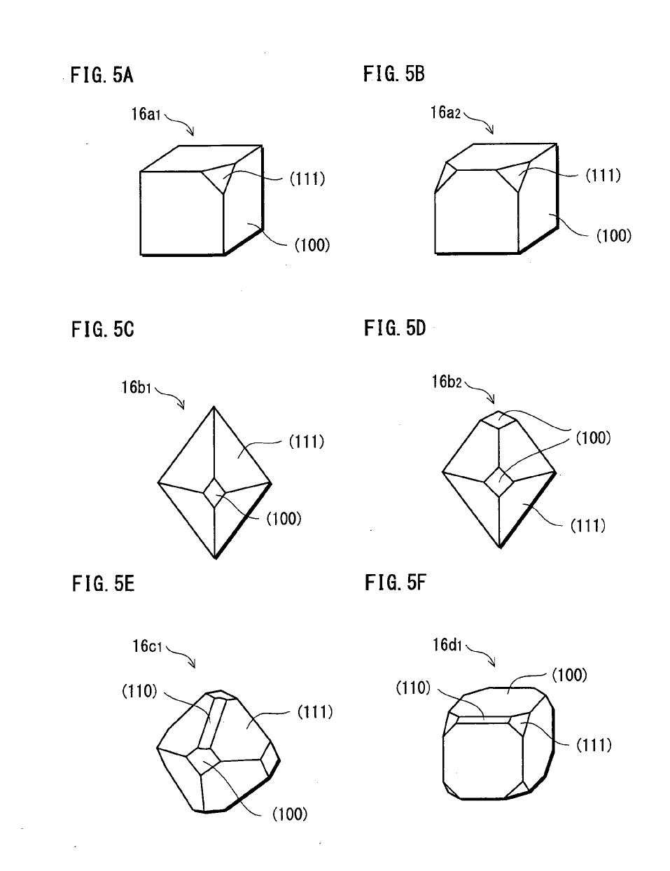

FIGS. 5A-5F are views showing variations of the shape of each MgO particle 16a-16d.

The MgO particle 16a may have any hexahedral crystal structure with at least one truncated surface. For example, a structure with one truncated surface is possible, like the MgO particle 16a1 shown in FIG. 5A, as is a structure with two truncated surfaces, like the MgO particle 16a2 shown in FIG. 5B. Herein, the truncated surface is the (111) crystal face, and the main surface is the (100) crystal face. Note that the hexahedral crystal structure with at least one truncated surface means a polyhedral structure having at least seven surfaces and that at least one of the surfaces is the truncated surface.

The MgO particle 16b may have any octahedral crystal structure with at least one truncated surface. For example, a structure with one truncated surface is possible, like the MgO particle 16b1 shown in FIG. 5C, as is a structure with two truncated surfaces, like the MgO particle 16b2 shown in FIG. 5D. Herein, the truncated surface is the (100) crystal face, and the main surface is the (111) crystal face. Note that the octahedral crystal structure with at least one truncated surface means that a polyhedral structure has at least nine surfaces and that at least one of the surfaces is the truncated surface.

The MgO particle 16c may have any octahedral crystal structure with at least one truncated surface and one oblique surface. For example, a structure with six truncated surfaces and one oblique surface is possible, like the MgO particle 16c1 shown in FIG. 5E. Herein, the main surface is the (111) crystal face, the truncated surface is the (100) crystal face, and the oblique surface is the (110) crystal face. Note that the octahedral crystal structure with at least one truncated surface and one oblique surface means that a polyhedral structure has at least ten surfaces, that at least one of the surfaces is the truncated surface, and that at least another one is the oblique surface.

The MgO particle 16d may have any hexahedral crystal structure with at least one truncated surface and one oblique surface. For example, a structure with eight truncated surfaces and one oblique surface is possible, like the MgO particle shown in FIG. 5F. Herein, the main surface is the (100) crystal face, the truncated surface is the (111) crystal face, and the oblique surface is the (110) crystal face. Note that the hexahedral crystal structure with at least one truncated surface and one oblique surface means a polyhedral structure has at least eight surfaces, that at least one of the surfaces is the truncated surface, and that at least another one is the oblique surface.

The MgO crystal particles in the present invention are not like MgO particles formed with a conventional method of precursor baking, with one specified side longer and flatter than other sides. Rather, as shown in FIGS. 4 and 5, the particles are fundamentally hexahedral or octahedral crystal structures, with the length of the sides within a specified range. When disposing the MgO powder 16 on the phosphor layer 14 in the PDP 1, MgO particles 16a, 16b, 16c, and 16d are used. The MgO particles 16a and 16b have an NaCl crystal structure with two specific crystal faces formed by the (100) crystal face and the (111) crystal face. The MgO particles 16c and 16d have an NaCl crystal structure with three specific crystal faces formed by the (100) crystal face, the (110) crystal face, and the (111) crystal face. In this way, by including MgO particles 16a-16d which have two specific crystal faces or three specific crystal faces in the MgO powder 16 and dispersing the MgO powder 16 in the inside of the phosphor layer 14 in the PDP 1, it is possible to exploit the characteristics of each crystal face, while also having the effect of allowing the characteristics to complement each other.

Concretely, among the three above-mentioned crystal faces, the (100) crystal face corresponds to the surface in which atoms are the most densely packed (the densest surface) and has the lowest surface free energy. Accordingly, it is chemically stable, barely adsorbing impurity gases (water, hydrocarbon, carbon dioxide, etc.) over a wide temperature range from a low temperature to a temperature equal to or higher than a normal temperature. That is, the MgO crystal does not have to suffer from undesirable chemical reactions that may be caused by the impurity gases. Thus, it is particularly expected that the characteristics of the (100) crystal face will make MgO crystal chemically stable even at a temperature lower than a normal temperature at which a conventional MgO crystal suffers from impurity gas adsorption (see Hyomen Gijutsu (Journal of the Surface Finishing Society of Japan) Vol. 41, No. 4, 1990, P. 50). Therefore, when the MgO crystal with the (100) crystal face is applied to the PDP, the absorption of the impurity gases (especially a hydrocarbon gas) inside the discharge space 15 can be suppressed over a wide temperature range, from a low temperature to a temperature equal to or higher than a normal temperature, and secondary electron emission characteristics can be maintained (see Journal of Chemical Physics Vol. 103, No. 8, 3240-3252, 1995).

The (100) crystal face has a low absolute amount of secondary electron emission over a wide temperature range from a low temperature to a temperature equal to or higher than a normal temperature. Accordingly, relying on the (100) crystal face alone will not yield sufficient secondary electron emission characteristics, and initializing bright points may occur.

This problem, however, can be controlled by simultaneously adopting the (111) crystal face and the (110) crystal face in the MgO particles. The (111) crystal face demonstrates good secondary electron emission characteristics over a wide temperature range from a low to a high temperature, and has particularly good electron emission characteristics at a normal temperature or higher. Therefore, this crystal face particularly has the effect of controlling the occurrence of initializing bright points in a temperature range equal to or higher than a normal temperature. The (110) crystal face also has excellent electron emission characteristics over a wide temperature range from a low to a high temperature. These abundant electrons can therefore be used to prevent the occurrence of initializing bright points more effectively.

In this way, the characteristics of each crystal face are complementary, thereby effectively preventing the occurrence of initializing bright points in the PDP 1.

In sum, by using the MgO particles 16a and 16b (with the (100) crystal face and the (111) crystal face), the MgO particles 16c and 16d (with the (100) crystal face, the (111) crystal face, and the (110) crystal face), or a combination of the MgO particles 16a-16d, a high secondary electron emission effect occurs, and the PDP 1 can be expected to prevent the occurrence of initializing bright points, particularly through abundant electron emission from the phosphor layer 14.

Below is a concrete summary of the principal advantages of the PDP 1.

First, as the PDP 1 is driven, when the 147 nm or 173 nm wavelength ultraviolet rays produced in the discharge space 15 reach the phosphor layer 14, the MgO particles 16a-16d packed in the gap between the phosphor particles receive the ultraviolet rays and demonstrate secondary electron emission characteristics. By using two or three specific crystal faces in the MgO particles 16a-16d, the particles have secondary electron emission characteristics dramatically superior to conventional particles as described above. The particles emit abundant secondary electrons in the discharge space 15 over a wide temperature range from a low to a high temperature.

Therefore, these properties can be exploited so that, by impressing a ramp waveform (FIG. 3) between the scan electrode 4 and the data electrode 11 during the initialization period, abundant emission of secondary electrons from the phosphor layer 14 towards the discharge space 15 will make an ideal weak discharge occur smoothly.

The occurrence of an undesirable strong discharge (initializing bright point), which can be seen by the naked eye, can thus be controlled, and a weak discharge can proceed smoothly. Therefore, the problem of lessened image display performance due to initializing bright points can effectively be prevented. Consequently, in the structure of the PDP, even if during voltage impression with a ramp waveform, a ramp waveform is impressed with the data electrode acting as the cathode, a weak discharge can be produced at a conventional value, without increasing the firing voltage Vf. Furthermore, this sort of positive effect is observed in any temperature range in the PDP's environment, from a low temperature to a relatively high temperature.

In this way, the present invention is both highly effective in preventing initializing bright points and is also quite viable.

Note that the crystal faces may not sufficiently demonstrate the above properties when the particle is small in size, or when the ratio of each crystal face to the total surface area of the MgO particle is small. As described later, MgO particles formed by the gas-phase oxidation method have various diameters, and thus an MgO particle with a diameter of below 300 nm may produce initializing bright points in the PDP or lead to discharge delays, even though the particle has a (100) crystal face. However, the MgO particles 16a-16d formed by baking the precursor each have a uniform diameter, and almost all the particles have a diameter of 300 nm and over as a primary particle. This allows almost all of the MgO particles 16a-16d to demonstrate the discharge properties for each crystal face. Therefore, the problems with MgO particles formed by the gas-phase oxidation method are avoided, and the excellent effects of suppressing initializing bright points are achieved uniformly.

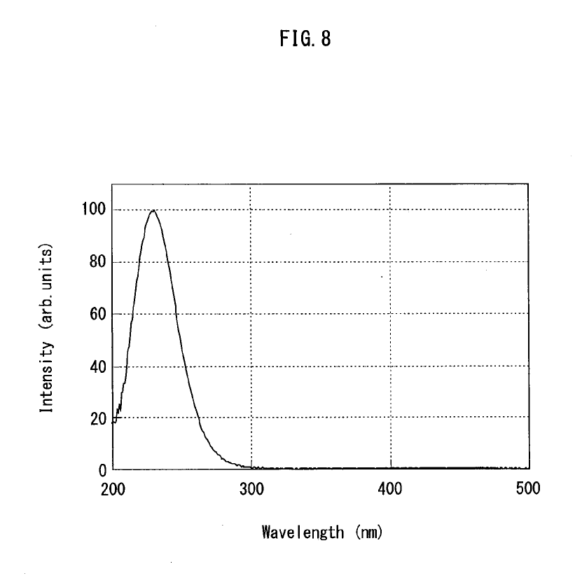

Second, by mixing the MgO particles 16a-16d into the phosphor layer, the emission rate of visible light of the phosphor particles can be improved. In other words, when the 147 nm or 173 nm wavelength vacuum ultraviolet light produced in the discharge space 15 reaches the MgO particles 16a-16d in the phosphor layer, the MgO particles 16a-16d are excited, and these particles both emitting secondary electrons as described above, while also producing ultraviolet rays with a wavelength in an approximate range of 200 nm-300 nm (see FIG. 8 described below).

The phosphor component receives both vacuum ultraviolet light from the discharge space 15 and ultraviolet rays from the MgO particles 16a-16d, which makes the visible light conversion process dynamic. In particular, in the phosphor layer 14 MgO particles 16a-16d surround the phosphor particles, making it possible efficiently to excite the phosphor particles from their surroundings. As a result, a superior emission rate of visible light produces light at a high degree of luminance. Furthermore, as compared to the 147 nm or 173 nm vacuum ultraviolet light, the ultraviolet rays with a wavelength in an approximate range of 200 nm-300 nm have a high energy conversion efficiency for MgO and encourage dynamic secondary electron emission. This sort of ultraviolet excitation effect on the phosphor particles, caused by using the MgO particles 16a-16d, is particularly effective with the present invention's MgO particles 16a-16d, which have specific cathodoluminescence properties.

Third, as the MgO particles 16a-16d have sufficiently high secondary electron emission characteristics as compared to the phosphor component, the variation in discharge characteristics, which are caused by each phosphor component in the phosphor layer of each color, become relatively less noticeable. As a result, it is possible to make the discharge characteristics uniform between discharge cells throughout the PDP, making for stable image display performance.

In sum, by disposing MgO particles 16a-16d in the phosphor layer 14 in the present invention, it is possible to control occurrence of initializing bright points, improve the quantity of visible light emitted by the phosphors, and prevent variation in the light intensity between phosphor layers of each color. Thus, the present invention promises dramatically superior image display properties as compared to a conventional structure.

### (Description of Cathodoluminescence Properties of MgO Particles)

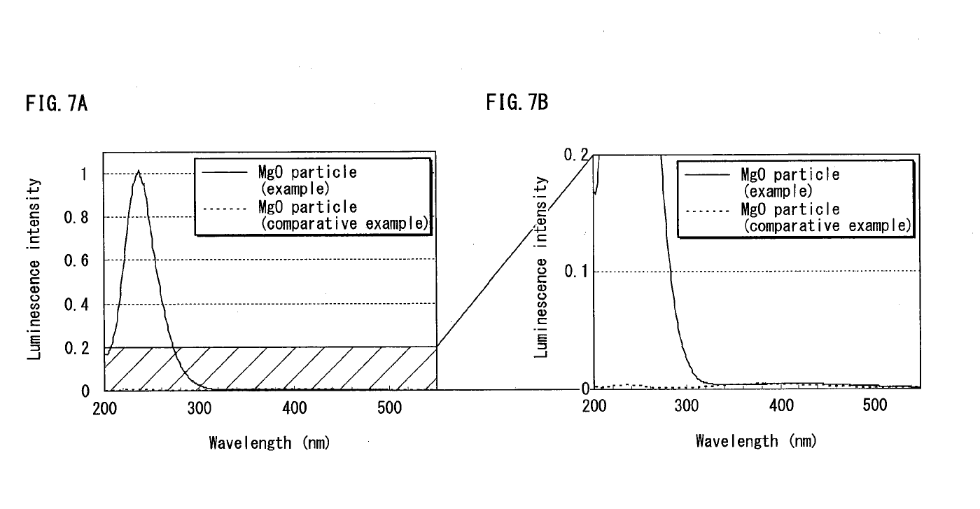

FIGS. 7A and 7B show the results of cathodoluminescence (CL) measurement performed on MgO particles formed by conventional the gas-phase oxidation method (Comparative Examples) and on the present invention's MgO particles 16a, 16b, 16c, and 16d (Examples), which have two or three specific crystal faces.

As shown in FIG. 7A, both the MgO particles in the Comparative Examples and in the Examples had an emission spectrum with a peak in a wide wavelength range of 200-500 nm in the CL spectra.

As shown in FIG. 7B, a maximum peak can be observed in the CL spectra in the 200-300 nm range for the embodiment. Light having CL spectra in the 200-300 nm range is also produced during discharge in the PDP. This maximum peak is not observed for the CL spectra of the MgO particles formed by the gas-phase oxidation method in the Comparative Examples.

In the embodiment, light energy of approximately 5 eV is produced upon discharge in a wavelength range of 200-500 nm having the maximum peak. This energy excites the MgO electrons in the MgO particles in the embodiment in FIGS. 7A and 7B when those electrons exist at an energy level within 5 eV from the vacuum level. The excited electrons are then emitted in the discharge space as secondary electrons.

Other consideration by the inventors of the present invention has also revealed that MgO particles formed by precursor baking as in the embodiment have higher electron emission characteristics as compared to MgO particles formed by the gas-phase oxidation method as in the comparative example. Therefore, confirming whether or not a maximum peak exists in the CL spectra in the 200-300 nm wavelength range serves as an effective evaluation guideline for the electron emission characteristics of MgO particles. Accordingly, the MgO particles in the present invention formed by precursor baking can be assessed as having a higher electron emission capability than MgO particles formed by the gas-phase oxidation method.

By disposing MgO particles 16a-16d in the phosphor layer 14 in the present invention, it is possible to emit secondary electrons effectively from the phosphor layer into the discharge space 15 when the PDP is driven. As a result, a weak discharge in the initialization phase can smoothly occur, making it possible to reduce the occurrence of initializing bright points.

Furthermore, as the MgO particles 16a-16d have sufficiently high secondary electron emission characteristics as compared to the phosphor component, the variation in discharge characteristics of each phosphor component in the phosphor layer 14 of each color becomes relatively less noticeable. As a result, it is possible to make the discharge characteristics uniform between discharge cells throughout the PDP, making for stable image display performance in the PDP 1.

As described above, in a PDP that has the MgO particles 16a, 16b, 16c and 16d with two or three specific crystal faces that emit deep ultraviolet (DITV) rays detectable by CL measurement, the PDP emits light with wavelengths of approximately 200-300 nm during discharge.

The surface ratios of the crystal faces in the crystal structure of each MgO particle 16a, 16b, 16c and 16d in accordance with Embodiment 1 are described as follows.

According to investigation by the inventors, the following surface ratios are desirable so as to effectively achieve the above effects in the PDP.

The surface ratio of the (100) crystal face to the total surface area of the MgO particle 16a favorably falls within a range between 50% and 98%, inclusive.

The surface ratio of the (100) crystal face to the total surface area of the MgO particle 16b favorably falls within a range between 30% and 50%, inclusive.

The surface ratio of the (111) crystal face to the total surface area of the MgO particle 16c favorably falls within a range between 10% and 80%, inclusive.

The surface ratio of the (100) crystal face to the total surface area of the MgO particle 16c favorably falls within a range between 5% and 50%, inclusive.

The surface ratio of the (110) crystal face to the total surface area of the MgO particle 16c favorably falls within a range between 5% and 50%, inclusive.

The surface ratio of the (111) crystal face to the total surface area of the MgO particle 16d favorably falls within a range between 10% and 40%, inclusive.

The surface ratio of the (100) crystal face to the total surface area of the MgO particle 16d favorably falls within a range between 40% and 80%, inclusive.

The surface ratio of the (110) crystal face to the total surface area of the MgO particle 16d favorably falls within a range between 10% and 40%, inclusive.

### (Confirmation of Ultraviolet Light Emission by the MgO Particles)

The ultraviolet light produced when the MgO particles produced by precursor baking in the present invention are excited by the vacuum ultraviolet light with a wavelength of 173 nm was actually confirmed via measurement. FIG. 8 shows an emission spectrum measured during an experiment.

As shown in FIG. 8, an ultraviolet ray waveform having a maximum peak in emission intensity in the 200-300 nm wavelength range can be observed. It has also been found that when these MgO particles are excited by vacuum ultraviolet light with a wavelength of 147 nm, similar ultraviolet rays are emitted.

By disposing the MgO particles 16a-16d which have these properties in the phosphor layer, the MgO powder 16 is excited by the vacuum ultraviolet light with a wavelength of 147 nm or 173 nm produced by the Xe gas in the PDP panel, and the MgO powder emits ultraviolet light with a wavelength of 200-300 nm. The phosphor material composing the phosphor layer is thus excited, making it possible to improve luminance.

In MgO particles formed by the conventional gas-phase oxidation method, this sort of ultraviolet light is either barely observed or is emitted in a relatively low amount. Therefore, mixing conventional MgO particles in the phosphor layer does not effectively increase visible light produced by the phosphors.

### (Specific Surface Area)

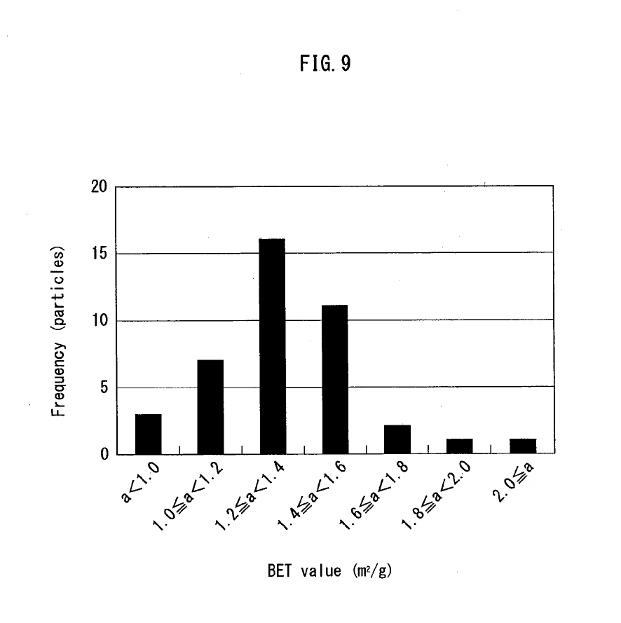

The MgO particles in the present invention were formed by baking the MgO precursor at a temperature range of 700° C. or greater and less than 2000° C., and the frequency of the BET values was measured. FIG. 9 shows the results of measurement.

Measurement of the specific surface area (BET value) was performed in accordance with the BET method: gas molecules (N₂) with a known adsorption area were adsorbed, and the specific surface area was calculated using the absorbed amount.

As shown in FIG. 9, the BET values for the MgO particles in the present invention vary slightly depending on the type or the baking profile of the MgO precursor, on the baking atmosphere, etc., but in general the values fell in a range of 1.0 m²/g to 2.0 m²/g, with the values being concentrated in a range of 1.0 m²/g or more and 1.6 m²/g or less.

Conversely, the BET values for MgO particles formed by the gas-phase oxidation method are approximately 7.0 m²/g.

It can thus be confirmed that the MgO particles formed by precursor baking have a smaller specific surface area than the MgO particles formed by the gas-phase oxidation method. This characteristic of the MgO particles in the present invention reduces the area of the MgO particles that comes into contact with undesirable gasses in the discharge space 15 as compared to conventional MgO particles. Therefore, it is considered that the amount of gas adsorbed is controlled, and that over time excellent adsorption resistance properties will be evidenced.

### Embodiment 2

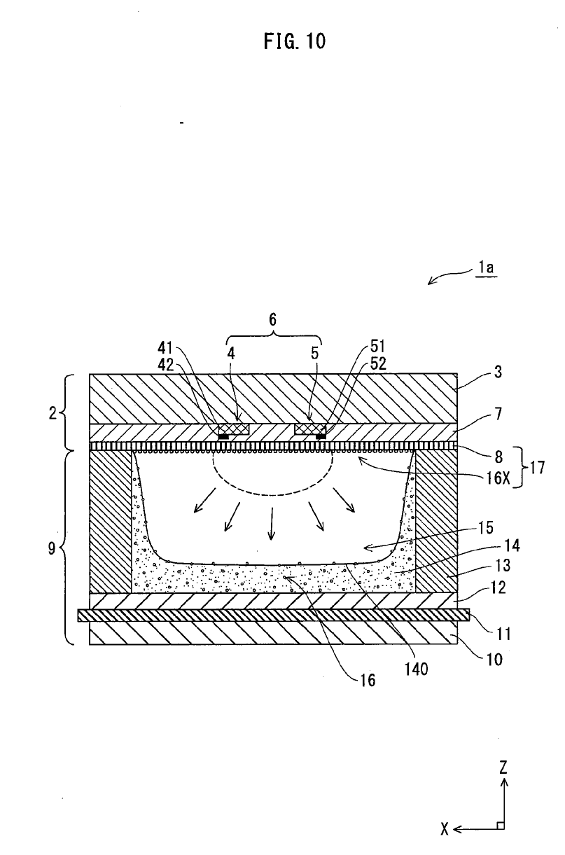

The following is a description of Embodiment 2 of the present invention, focusing on the differences with Embodiment 1. FIG. 10 is a cross-sectional view of the PDP 1a in Embodiment 2.

The PDP 1a is characterized by having MgO powder 16X disposed on the surface layer 8 of the front panel 2, and by having the protective layer 17 formed by a multilayered structure consisting of the surface layer 8 and the MgO powder 16X. Like the MgO powder 16, the MgO powder 16X includes the MgO particles 16a-16d.

In addition to yielding the same results as the PDP 1, by disposing the MgO powder 16X, the PDP 1a with this structure promises even greater suppression of initializing bright points and improved luminance of the entire PDP.

In conventional PDPs, the vacuum ultraviolet light with a wavelength of 147 nm or 173 nm produced as a spherical wave by the discharge gas in the discharge space does not actually contribute to visible light in the protective layer made of MgO on the front panel side, and ends up being absorbed in this protective layer. Therefore, out of the vacuum ultraviolet rays in the spherical wave, only a portion of the ultraviolet rays that reach the phosphor layer are accompanied by visible light in the phosphors, and the remaining ultraviolet rays radiated on the front panel are ineffective, as they hardly contribute to emission of visible light.

In PDP 1a, however, in addition to the MgO powder 16 in the phosphor layer 14 disposed on the back panel 9, MgO powder 16X is further disposed on the surface layer 8 placed on the front panel 2. The MgO powder 16X is irradiated efficiently by the ultraviolet rays with a wavelength of 147 nm or 173 nm produced as a spherical wave. Thus, the phosphor particles 16a-16d in the phosphor layer 14 are more efficiently excited, as they are not only excited directly by the ultraviolet rays with a wavelength of 147 nm or 173 nm produced as a spherical wave, but also receive ultraviolet rays with a wavelength of 200-300 nm, a relatively long wavelength. These ultraviolet rays are emitted by the MgO particles on both the back panel 9 and the front panel 2, the MgO particles having been excited by the ultraviolet rays from the spherical wave. As a result, the phosphor particles in the phosphor layer 14 make use of the entire surface to emit abundant visible light.

Furthermore, the MgO particles 16a-16d disposed on both the front panel 3 and the back panel 9 both receive the ultraviolet light emission produced as a spherical wave, thereby discharging an abundance of secondary electrons in the discharge space 15. These secondary electrons are then used to produce a sufficient discharge in the discharge space 15.

Also, the 200-300 nm ultraviolet light emitted by the MgO particles 16a-16d has a longer lifespan than the ultraviolet light produced by the 147 nm or 173 nm vacuum ultraviolet light produced by the Xe gas in the discharge gas. For this reason, by being continually exposed to the ultraviolet rays produced by the MgO particles 16a-16d, the electrons in the phosphor layer 14 continue to exist at a relatively low energy level, yielding the effect of improving the electron emission characteristics of the phosphors.

A further characteristic of the PDP 1a is that, by using MgO particles 16a-16d, improvements can be expected in the problematic areas of discharge delay, dependence of discharge delay on temperature, and dependence of discharge delay on space charges.

In general, the problem of discharge delay in a PDP occurs when, in the surface layer that includes MgO, the MgO particle crystals only have crystal faces with low secondary electron emission characteristics. The crystal face (100) can be considered an example of this sort of undesirable crystal face.

The PDP 1a, however, uses a mix of MgO particles 16a and 16b, which have an NaCl crystal structure with two specific crystal faces, and MgO particles 16c and 16d, which have an NaCl crystal structure with three specific crystal faces, or a mix of MgO particles 16a-16d in the MgO powder 16X on the surface layer 8. This also produces positive effects against the problem of discharge delay.

In other words, when the PDP 1a is driven, the characteristics of both the (100) crystal face and the (111) crystal face combine to produce the following effects: prevention of adsorption of impure gasses over a wide temperature range, from a low temperature (upon initial driving of the PDP, or when the PDP is used in an area with a low ambient temperature) to a temperature equal to or higher than a normal temperature (once a certain time has elapsed after driving begins, or when the PDP is used in an area with a high ambient temperature); maintenance of stable electron emission characteristics; and abundant emission of electrons in the discharge space. Thus, both the problems of “discharge delay” and “dependence of discharge delay on temperature” can be effectively controlled.

Furthermore, the characteristics inherent to the MgO particles 16c and 16d which are provided with the crystal face (110), permit sufficient electron emission characteristics to be obtained during initial driving of the PDP without the assistance of the space charge produced upon discharge initiation. This leads to stable electron emission regardless of the number of pulses (number of sustain pulses) impressed on the display electrode pairs 6 during the sustain discharge period. In other words, this has the effect of reducing dependence of discharge delay on space charges.

In this way, by making use of MgO particles that have two specific crystal faces, the PDP 1a can take advantage of the characteristics of each crystal face, while letting the characteristics of the crystal faces complement each other, in order to control “discharge delay” and “dependence of discharge delay on temperature.”

Furthermore, by making use of MgO particles that have three specific crystal faces, the PDP 1a can take advantage of the characteristics of each crystal face, while letting the characteristics of the crystal faces complement each other, in order to control not only “discharge delay” and “dependence of discharge delay on temperature ” but also “dependence of discharge delay on space charges,” thereby promising even better image display performance.

### Other Embodiments

The following is a description of Embodiments 3 and 4, focusing on the differences with Embodiments 1 and 2.

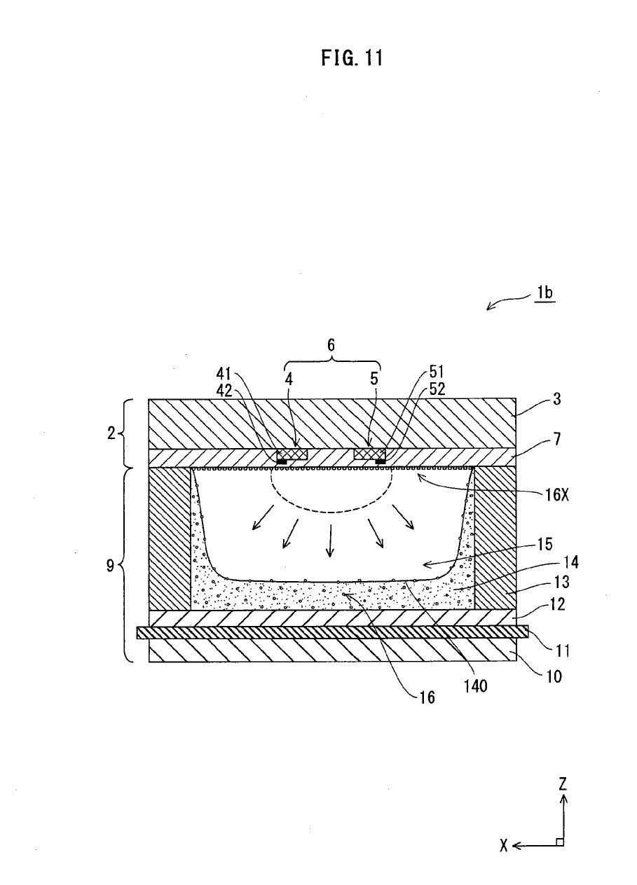

FIG. 11 is a cross-sectional view of the structure of the PDP 1b in Embodiment 3. The PDP 1b has nearly the same structure as the PDP 1a, but does not include the surface layer 8, and has the MgO powder 16X composed of MgO particles 16a-16d disposed directly on the surface of the dielectric layer 7.

With this kind of structure, the PDP 1b also demonstrates nearly the same effects as the PDP 1a, namely: suppression of initializing bright points by ensuring secondary electron emission characteristics during driving in the MgO powder 16X, brightening of emitted visible light, suppression of variation of discharge characteristics between discharge cells, etc. Furthermore, the PDP 1b can control not only “discharge delay” and “dependence of discharge delay on temperature,” but also “dependence of discharge delay on space charges.”

Since the PDP 1b does not have a surface layer 8, the ratio of visible light transmitted through the front panel 2 correspondingly increases, thereby increasing the luminance of emitted light. Additionally, the thin film formation process for creating the surface layer 8 is no longer necessary, thereby having the effect of simplifying both the PDP's structure and its manufacturing process.

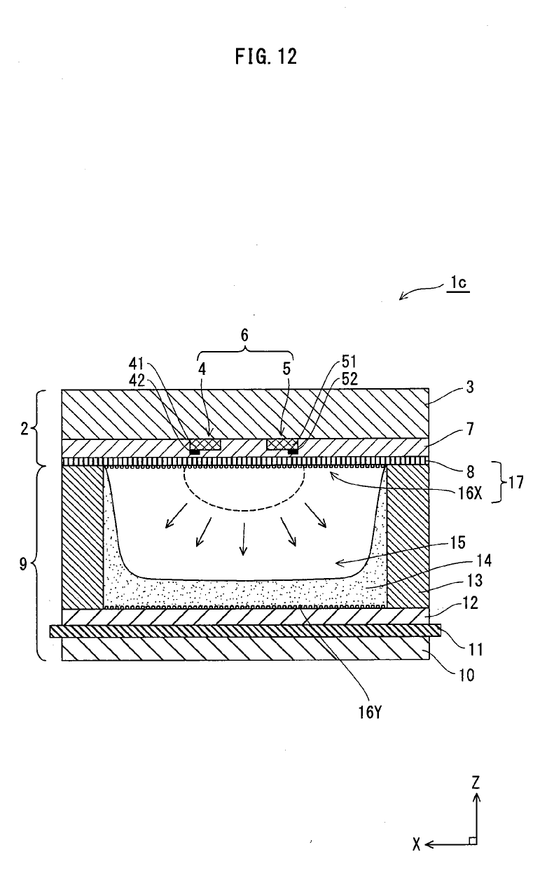

FIG. 12 is a cross-sectional view of the structure of the PDP 1c in Embodiment 4. The PDP 1c is characterized by having MgO powder 16Y, comprising MgO particles 16a-16d, disposed along the bottom of the phosphor layer 14 in the back panel 9.

With this kind of structure, the PDP 1c also demonstrates nearly the same effects as the PDP 1. Also, since an underlayer of MgO powder 16Y is disposed in the phosphor layer 14, even if visible light is emitted from the surface of phosphor particles in the phosphor layer 14 in the direction of the back panel, such visible light will be reflected by the MgO powder 16Y towards the front panel 2, thereby effectively contributing to image display. As a result, excellent image display performance at an even higher degree of luminance can be expected.

In addition to the structure shown in FIG. 12, MgO particles 16a-16d can also be dispersed inside the phosphor layer 14 in the PDP 1c.

The structures of the PDP 1 and the PDP 1a-1c can also be combined as long as such a combination is coherent.

### <Production Method of PDP>

The following is a description of the production method of the PDP 1 and PDP2 in accordance with each embodiment of the present invention. The main difference between the PDP 1 and PDP 1a-1c is the structure around the surface layer 8 and the phosphor layer 14. The production process for other parts is identical.

### (Production Method of MgO Particles)

As an example of how to form the MgO particles 16a-16d, high-purity MgO compound (MgO precursor) is equally treated with heat and baked in an oxygen-containing atmosphere at a high temperature (700° C. or higher).

In the embodiments of the present invention, the magnesium compound for the MgO precursor may be at least one (or may be a mixture of two or more) of magnesium hydroxide, magnesium alkoxide, acetylacetone magnesium, magnesium nitrate, magnesium chloride, magnesium carbonate, magnesium sulfate, magnesium oxalate, and magnesium acetate. Some of the compounds listed above are present generally in hydrated form. Such magnesium hydrate is also applicable.

The purity of the magnesium compound for the MgO precursor is favorably 99.95% or more, and more favorably 99.98% or more for the following reason. When many impurity elements such as alkali metals, boron, silicon, iron and aluminum are contained in the magnesium compound, there is a risk that the particles of the compound will fuse and sinter together during the heat treatment (especially at a high baking temperature), and therefore that the high-crystalline MgO particles will be unlikely to grow. On the other hand, the high-purity magnesium compound prevents such a problem.

When such a high-purity MgO precursor is baked in an oxygen-containing atmosphere, the MgO particles 16a-16d can be formed as highly pure as 99.95% or more, or as 99.98% or more.

The baking temperature of the MgO precursor is favorably 700° C. or more, and more favorably 1000° C. or more. This is because the crystal faces do not grow properly, having crystal defects, at a baking temperature lower than 700° C., and therefore the particles adsorb much impurity gas. Note that when the baking temperature reaches 2000° C. or higher, the oxygen escapes from the particles, which results in crystal defects causing the adsorption of much impurity gas. Thus, the favorable baking temperature is 1800° C. or below.

The MgO precursor baked at a temperature ranging from 700° C. to 2000° C., inclusive, develops into to the MgO particles 16a-16d with the two or three specific crystal faces. According to another experiment carried out by the inventors, it was observed that the (110) crystal face tends to shrink when the precursor is baked at a temperature of approximately 1500° C. or higher. Thus, in order to enhance the yield of the MgO particles 16c and 16d having the three specific crystal faces, the baking temperature desirably ranges from 700° C. to lower than 1500° C. On the other hand, in order to enhance the yield of the MgO particles 16a and 16b, the baking temperature desirably falls in a range of 1500° C.-2000° C., inclusive.

Note that the MgO particles 16a-16d may be separated from each other through a screening printing process.

The following is a concrete description of a process for forming magnesium hydroxide that is an MgO precursor with the use of liquid phase forming methods. The process for forming the MgO powder including the MgO particles 16a-16d from the magnesium hydroxide is also described concretely.

(1) As a starting material, magnesium alkoxide (Mg(OR)₂) or acetylacetone magnesium of a purity greater than or equal to 99.95% is prepared and dissolved in a solution. The solution is hydrolyzed with a small amount of acid, and thus magnesium hydroxide gel that is the MgO precursor is obtained. Subsequently, the gel is baked in an atmosphere at a temperature ranging from 700° C. to 2000° C., inclusive, for dehydration. Thus, the powder having the MgO particles 16a-16d is formed.

(2) As a starting material, magnesium nitrate (Mg(NO₃)₂) of a purity greater than 99.95% is prepared and dissolved in a solution. An alkali solution is added to the solution of magnesium nitrate (Mg(NO₃)₂), and thus a magnesium hydroxide precipitation is obtained. The magnesium hydroxide precipitation is separated from the solution, and then is baked in an atmosphere at a temperature ranging from 700° C. to 2000° C., inclusive, for dehydration. Consequently, the precipitation forms the powder having the MgO particles 16a-16d.

(3) As a starting material, magnesium chloride (MgCl₂) of a purity greater than or equal to 99.95% is prepared and dissolved in a solution. Calcium hydroxide (Ca(OH)₂) is added to the solution of magnesium chloride (MgCl₂), and thus, a magnesium hydroxide (Mg(OH)₂) precipitation that is the MgO precursor is obtained. Subsequently, the magnesium hydroxide precipitation is separated from the solution, and then is baked in the air at a temperature ranging from 700° C. to 2000° C., inclusive, for dehydration. Thus, the precipitation forms the powder having the MgO particles 16a-16d.

With use of the liquid phase forming methods (1)-(3) in which the solution of magnesium alkoxide (Mg(OR)₂), magnesium nitrate (Mg(NO₃)₂), or magnesium chloride (MgCl₂), each of which is of a purity greater than or equal to 99.95%, is hydrolyzed adding the acids or alkalis whose concentrations are controlled, a magnesium hydroxide (Mg(OH)₂) precipitation having extremely fine crystal grains can be achieved. Baking the precipitation in the atmosphere at 700° C. or higher separates H₂O (water) from (Mg(OH)₂), and thus the MgO powder is formed. The MgO powder formed as above has few crystal defects, and accordingly scarcely adsorbs a hydrocarbonic gas.

Generally, the MgO particles formed by a conventional gas-phase oxidation method comparatively demonstrate more variations in diameter.

Because of this, in a conventional forming process, a screening process is necessary to select particles with a roughly uniform diameter so that the particles have uniform discharge properties (disclosed in Japanese Patent Application Publication No. 2006-147417).

In accordance with the embodiments of the present invention, however, although the MgO particles are also obtained by baking the MgO precursor, compared with those formed by the conventional forming method, the MgO particles each have a uniform diameter within a given size range. More specifically, the size of the MgO particles in accordance with the embodiments falls within a range of 300 nm-2 μm. Each particle in the embodiments has a smaller specific surf ace area than a crystal formed by the gas-phase oxidation method, which is one reason why the MgO particles 16a-16d do not adsorb much impurity gas and thereby efficiently emit secondary electrons. In addition, since the particles each have a uniform diameter, the screening process to sort out undesirable particles can be omitted. This simplified process brings about a significant advantage in production efficiency and production cost.

Note that Mg(OH)₂, the MgO precursor, is a compound that has a hexagonal crystal structure, which is different from MgO having an octahedral (eight regular surfaces) cubic structure. Although the crystal growth process in which Mg (OH)₂ is pyrolyzed to form the MgO crystal is complicated, the MgO crystal is based on the hexagonal crystal structure of Mg (OH)₂ in the crystal growth. As a result, the (100), (111) and (110) crystal faces are formed.

On the other hand, when the MgO crystal is formed with a vapor phase synthetic method, only a particular crystal face is likely to grow. For example, direct oxidation of Mg (magnesium metal) is used for forming the MgO powder as follows: magnesium metal is heated at a high temperature in a bath filled with an inert gas, and the magnesium is directly oxidized by adding a small amount of oxygen gas to the bath. However, this method causes the crystal faces to grow mainly in the (100) direction because magnesium adsorbs the oxygen gas. Consequently, the crystal faces oriented in other directions are unlikely to grow.

The MgO particles can also be obtained by the following method similarly to the above method in which magnesium hydroxide is baked. The magnesium compound that does not have a sodium chloride type crystal structure (cubic crystal structure) is directly baked as an MgO precursor at a temperature of 700° C. or higher to be in a thermal equilibrium state. Such a magnesium compound includes magnesium alkoxide, magnesium nitrate, magnesium chloride, magnesium carbonate, magnesium sulfate, magnesium oxalate, and magnesium acetate. When a (OR)₂, Cl₂, (NO₃)₂, CO₃, or C₂O₄ group, a coordinating atom of Mg, is eliminated from the magnesium compound, a crystal structure forming mechanism makes the (110) and (111) crystal faces grow as well as the (100) crystal face. Thus, the powder of the MgO particles 16a-16d having the two or three specific crystal faces can be obtained.

### (Manufacturing of Front Panel 2)

On the surface of the front panel glass 3 made of soda-lime glass with a thickness of approximately 2.6 mm, the display electrode pairs 6 are formed. The printing method is shown here as an example to form the display electrode pairs 6. However, the display electrode pairs 6 may be formed by a dye coat method, blade coat method, or the like.

To begin with, on the front panel glass 3, transparent electrode materials such as ITO, SnO₂, and ZnO are applied in a given pattern such as a stripe pattern and dried. Thus, transparent electrodes 41 and 51 with a thickness of approximately 100 nm are formed.

Meanwhile, a photosensitive paste is prepared by blending Ag powder and an organic vehicle with a photosensitive resin (photodegradable resin). The photosensitive paste is applied on the transparent electrodes 41 and 51, and the transparent electrode 41 and 51 are covered with a mask having an opening that matches the pattern of the bus lines. After a development process in which exposure is performed on the mask, the photosensitive paste is baked at a baking temperature of approximately 590-600° C. Thus, the bus lines 42 and 52 with a final thickness of some micrometers are formed on the transparent electrodes 41 and 51. Though the screen method can conventionally produce a bus line with a width of 100 μm at best, this photomask method enables the bus lines 42 and 52 to be formed as thin as 30 μm. Besides Ag, the bus lines 42 and 52 can be made of other metal materials such as Pt, Au, Al, Ni, Cr, tin oxide and indium oxide. Other than the above methods, the bus lines 42 and 52 can be formed by etching a film having been formed by the deposition method or the sputtering method.

Subsequently, a paste is prepared by mixing (i) lead-based or lead-free low-melting glass or SiO₂ powder whose softening point is 550° C.-600° C. with (ii) organic binder such as butyl carbitol acetate. The paste is applied on the display electrode pairs 6, and baked at a temperature ranging from 550° C. to 650° C. Thus, the dielectric layer 7 with a final thickness of some micrometers to some tens of micrometers is formed.

To manufacture the PDP 1, 1a, and 1c, a surface layer with a predetermined thickness is next formed as a film on the surface of the dielectric layer. The deposition method is used for forming the film, and in an oxygen environment, a Pierce electron gun is used as a heat source to heat the deposition source. The amount of current in the electron beam, the partial pressure of oxygen, the temperature of the substrate, etc. at the time of film formation do not have a major impact on the composition of the surface layer after film formation and can thus be set arbitrarily. Note that the method for forming the film is not limited to the above EB method; any other thin film method such as the sputtering method, ion plating method, etc. can also be used.

Furthermore, when manufacturing the PDP 1a-1c, MgO powder 16X is formed on the surface of the dielectric layer 7 or the surface layer 8. A dispersion liquid including the MgO particles 16a-16d is applied via the screen printing method, the spray method, etc., the solvent is subsequently removed, and the remaining substance is sufficiently dried to form the MgO powder 16X.

The above process is used to manufacture the front panel 2.

### (Manufacturing the Back Panel)

On the surface of the back panel glass 10 made up of soda-lime glass with a thickness of approximately 2.6 mm, conductive materials mainly composed of Ag are applied with the screen printing method in a stripe pattern at a given interval. Thus, the data electrodes 11 with a thickness of some micrometers (e.g. approximately 5 μm) are formed. The data electrodes 11 are made up of a metal such as Ag, Al, Ni, Pt, Cr, Cu, and Pd or a conductive ceramic such as metal carbide and metal nitride. The data electrodes 11 may be made of a composition of these materials, or may have a layered structure of these materials as necessary.

The gap between each two adjacent data electrodes 11 is set to 0.4 mm or below so that the PDP 1 has a 40-inch screen in conformity with the NTSC or VGA specification.

Next, a glass paste with a thickness of approximately 20-30 μm made of lead-based or lead-free low-melting glass or SiO₂ material is applied and baked over the back panel glass 10 and the data electrodes 11 in order to form the dielectric layer 12.

Subsequently, the barrier ribs 13 are formed on the dielectric layer 12 as follows. The low-melting glass paste is applied and baked on the dielectric layer 12. The paste is formed, using a sandblast method or a photolithography method, in a grid pattern dividing the borders of a plurality of adjacent discharge cells (not illustrated) arranged in rows and columns.

After forming the barrier ribs 13, on the lateral surface of each barrier rib 13 and on the surface of the dielectric layer 12 exposed between barrier ribs, the phosphor layer 14 is formed so as to contain one of red (R), green (G), or blue (B) phosphors.

When manufacturing the PDP 1c, a dispersion liquid made by dispersing MgO particles in a solvent is applied to the surface of the dielectric layer 12 and dried to form the MgO powder 16Y.

The following compositions can be used in each of the RGB phosphors.

Red phosphor Y₂O₃: Eu³⁺

Green phosphor Zn₂SiO₄:Mn.

Blue phosphor BaMgAl₁₀O₁₇:Eu²⁺

Any known method for the formation of the phosphor layer, such as the electrostatic coating method, the spray method, the screen printing method, etc., may be used.

When, from among these methods, the electrostatic coating method is used, ethylcellulose and α-terpineol are used as the solvent and the dispersion liquid respectively, to which phosphor powder with a mean particle diameter of 2.0 μm is added and mixed in a sand mill. This manufactures a phosphor ink with a viscosity of approximately 15×10⁻³ Pa·s. This phosphor ink is injected into the server and is sprayed by a pump through a nozzle that has a diameter of 60 μm to apply to ink between adjacent barrier ribs 13. At that time, the panel is moved in the longitudinal direction of the barrier ribs 13. Accordingly, the ink is applied in a stripe pattern on the panel. After application is complete, the phosphor ink is baked for 10 minutes at 500° C., and the solvent and dispersion liquid are removed. Thus, the phosphor layers 14 with the MgO powder 16X dispersed in the layers are formed.

MgO particles can be disposed on the surface of the phosphor layers 140 by manufacturing a dispersion liquid made by dispersing MgO particles in a solvent, dispersing the liquid via the electrostatic coating method, the spray method, the screen printing method, etc., and then drying the liquid and allowing it to set.

### (Completion of the PDP)

The front panel 2 and the back panel 9 are sealed together with use of sealing glass. Thereafter, the interior of the discharge space 15 is highly vacuumed (1.0×10⁻⁴ Pa) thereby removing the atmosphere and impurity gas from the discharge space 15. In the discharge space 15, Xe mixed gas such as an Ne—Xe mixture, an He—Ne—Xe mixture, or an Ne—Xe—Ar mixture gas is filled as discharge gas at a given pressure (66.5 kPa-101 kPa in these embodiments). The concentration of the Xe gas in the mixed gas falls in a range of 15%-100%.

The PDP 1 and PDP 1a-1c are complete after having gone through the above processes.

In these embodiments, the front panel glass 3 and the back panel glass 10 are made of soda-lime glass. However, this is merely an example, and other materials may be used.

### <Performance Evaluation Experiment>

Examples of the present invention were manufactured along with Comparative Examples, and performance evaluation experiments were carried out on the present invention. The results are shown below. Note that of course neither the structure of the Examples nor the method used for the performance evaluation experiments is meant in any way to limit the present invention.

### Experiment 1

Varying amounts of MgO particles formed by the gas-phase oxidation method and by the precursor baking method were combined with a phosphor component and disposed respectively as the phosphor layer in PDPs. Each of the PDPs was then driven to investigate the relationship between the weight concentration of the MgO particles and change in luminance. The blue phosphor BaMgAl₁₀O₁₇: Eu, which has ordinary phosphor characteristics, was used. As for the MgO particles, Example MgO particles 1 and 2 were formed by using magnesium hydroxide as a precursor, baked respectively at 1200° C. and 1000° C., and Comparative Example MgO particles 3 were formed by the gas-phase oxidation method. The BET values for the MgO particles 1-3 were 1.0 m²/g, 2.0 m²/g, and 7.1 m²/g respectively.

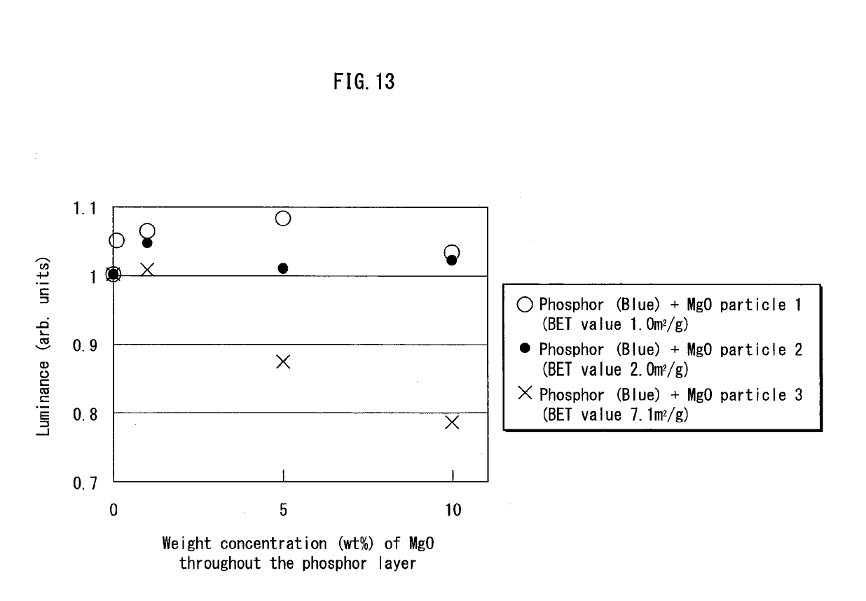

FIG. 13 shows the results of the present experiment. As shown in the figure, luminance decreased dramatically as the amount of mixing increased for MgO particles 3, and it was observed that when the weight concentration throughout the phosphor layer reached 10 wt %, luminance fell to approximately 80%. It is considered that luminance was reduced because the visible light emitted by the phosphors was either blocked or reflected diffusely by the MgO particles, and was thus impeded from traversing the front panel well.

Variation in particle size for the MgO particles 3 formed by the gas-phase oxidation method was relatively large, and at a microscopic level, several very fine particles existed around the crystal particles with a large particle size, making the BET value large. Using this sort of MgO particles leads to undesirable diffusion of visible light and can negatively influence image display performance.

In contrast, the BET values for the MgO particles 1 and 2 were kept low at 1.0 m²/g and 2.0 m²/g respectively, and even when the weight concentration throughout the phosphor layer reached 10 wt %, the decrease in luminance was not as noticeable as compared to the MgO particles 3. This was considered to result from compensation for the cause of reduction in luminance in the MgO particles 3, because for MgO particles 1 and 2, the visible light emitted from the phosphors in spherical form is reflected well by the MgO particles with a small BET value existing in the gaps in the phosphor layer, and diffuse reflection at that time is prevented. It is clear that the effects of refection of visible light grow larger as the BET value grows smaller, and that diffuse reflection of visible light from the phosphors can also be suppressed as the BET value grows smaller.

In the case of the MgO particles 1 with a BET value of 1.0 m²/g, luminance increases along with the weight concentration of the MgO particles, with a maximum luminance on the graph when the weight concentration was approximately 5 wt %. Consequently, the actual maximum value for luminance is considered to lie within a range of 5 wt % or greater and 10 wt % or less. Thus, for the MgO particles 1 and 2, even if the weight concentration of the MgO particles increases, luminance tends not to decrease. This is considered to be the reason why an overall increase in luminance was obtained when these particles were excited by the ultraviolet rays with a wavelength of 147 nm or 173 nm received from the discharge space, the particles themselves then emitting ultraviolet rays with a wavelength of 200-300 nm, which caused the phosphor particles surrounded by the MgO particles to emit visible light effectively.

The MgO particles formed by the gas-phase oxidation method (MgO particles 3) release fewer secondary electrons than the MgO particles formed by precursor baking (MgO particles 1, 2). As a result, in order to prevent the occurrence of initializing bright points effectively and to achieve the desired effects, a much greater amount of particles formed by the gas-phase oxidation method must be disposed in the phosphor layer than when using MgO particles formed by precursor baking. However, as shown in the above-mentioned graph, MgO particles formed by the gas-phase oxidation method have the problem that as the weight concentration of the MgO particles increases, luminance decreases. Accordingly, in order to make the prevention of the occurrence of initializing bright points compatible with improved luminance, it is preferable to use MgO particles formed by precursor baking, as in the present invention.

### Experiment 2

Next, Examples and Comparative Examples were prepared as PDP samples 1-8, and both the rate of occurrence of initializing bright points and luminance were investigated. Samples 2-4 (Examples 1-3) were made in accordance with PDP 1 in Embodiment 1, and samples 6-8 (Examples 4-6) were made in accordance with the structure of PDP 1a in Embodiment 2.

The rate of occurrence of initializing bright points was measured by breaking an image down into RGB components through image processing and calculating the light emission area per unit of area. First, the PDPs in each sample were made to produce initializing bright points. The display was captured as an image, downloaded onto a computer, and broken down into RGB components. A threshold value for emission intensity was determined for the image, and the existence of light emission was determined based on whether the threshold value was exceeded or not. The occurrence rate of initializing bright points was calculated via the area of the sections with light emission per unit of area.

Luminance was measured with a luminance meter when each sample PDP was driven with a discharge sustain voltage of 180V and a frequency of 200 kHz.

Samples were coordinated as follows.

Sample 1 (Comparative Example 1): this sample was made as the most basic conventional structure of a PDP, with no MgO powder disposed in either the phosphors in the back panel or on the dielectric layer on the front panel.

Sample 2 (Example 1): this sample was made by disposing MgO particles in the phosphor layer on the back panel, the particles being formed by baking a precursor of magnesium hydroxide with 0.5 wt % at 1200° C., without disposing MgO particles on the dielectric layer on the front panel.

Sample 3 (Example 2): this sample was made by disposing MgO particles in the phosphor layer on the back panel, the particles being formed by baking a precursor of magnesium hydroxide with 2 wt % at 1200° C., without disposing MgO particles on the dielectric layer on the front panel.

Sample 4 (Example 3): this sample was made by disposing MgO particles in the phosphor layer on the back panel, the particles being formed by baking a precursor of magnesium hydroxide with 10 wt % at 1200° C., without disposing MgO particles on the dielectric layer on the front panel.

Sample 5 (Comparative Example 2): this sample was made without disposing MgO particles in the phosphor layer on the back panel, but rather disposing MgO particles formed by precursor baking on the dielectric layer on the front panel.

Sample 6 (Example 4): this sample was made by disposing MgO particles in the phosphor layer on the back panel, the particles being formed by baking a precursor of magnesium hydroxide with 0.5 wt % at 1200° C., and also disposing MgO particles formed by precursor baking on the dielectric layer on the front panel.

Sample 7 (Example 5): this sample was formed by disposing MgO particles in the phosphor layer on the back panel, the particles being formed by baking a precursor of magnesium hydroxide with 2 wt % at 1200° C., and also disposing MgO particles formed by precursor baking on the dielectric layer on the front panel.

Sample 8 (Example 6): this sample was made by disposing MgO particles in the phosphor layer on the back panel, the particles being formed by baking a precursor of magnesium hydroxide with 10 wt % at 1200° C., and also disposing MgO particles formed by precursor baking on the dielectric layer on the front panel.

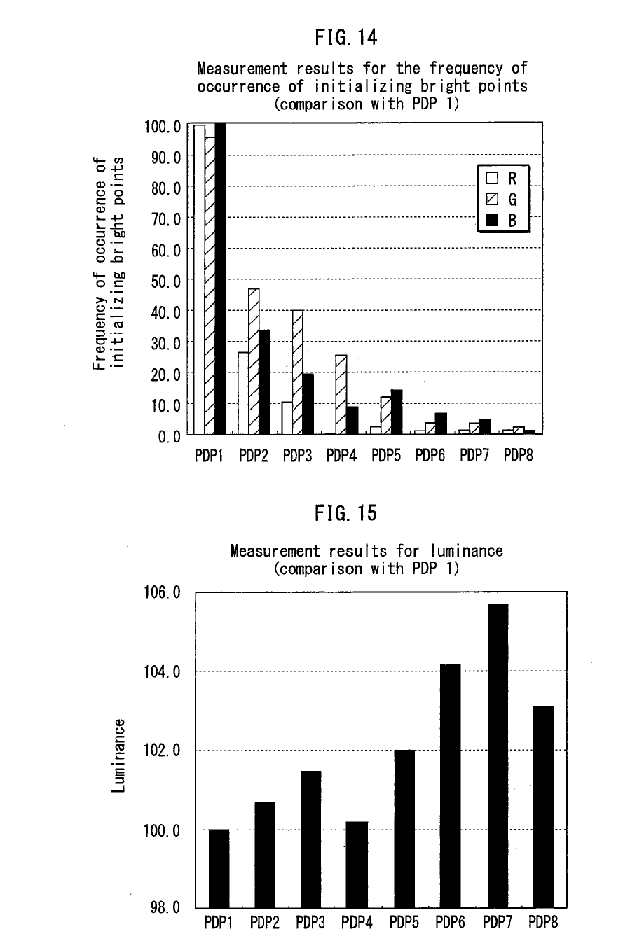

For the sample PDPs made with the above-described conditions, the measurement results for the frequency of occurrence of initializing bright points are shown in FIG. 14, and the measurement results for luminance are shown in FIG. 15. Both FIGS. 14 and 15 are graphs of values as compared to the measured values for sample 1.

The results shown in FIG. 14 demonstrate that the frequency of occurrence of initializing bright points as compared to Sample 1 (Comparative Example 1) decreases in Samples 2, 3, and 4 (Examples 1, 2, and 3), which correspond to the structure of Embodiment 1, and that these samples have a particularly superior performance as a PDP. This is considered to be because combining a phosphor component with MgO particles formed by precursor baking dramatically enlarged the secondary electron emission coefficient γ for the entire phosphor layer. Furthermore, it was noted that as the weight concentration of the MgO particles in the phosphor layer increases, the frequency of occurrence of initializing bright points dramatically decreases.

The results shown in FIG. 15, on the other hand, demonstrate that as compared to Sample 1 (Comparative Example 1), luminance increases in Samples 2, 3, and 4 (Examples 1, 2, and 3), which correspond to the structure of Embodiment 1, and that these samples have a particularly superior image display performance as a PDP. In this experiment, the MgO particles in the phosphor layer with a weight concentration of 2 wt % resulted in the highest luminance.

Furthermore, the frequency of occurrence of initializing bright points as compared to Sample 5 (Comparative Example 2) decreases in Samples 6, 7, and 8 (Examples 4, 5, and 6), which correspond to the structure of Embodiment 2, and these samples were shown to have sufficient characteristics (FIG. 14). Samples 6, 7, and 8 (Examples 4, 5, and 6) were also confirmed to have even better performance with regards to suppression of initializing bright points and improvement of luminance than Samples 2, 3, and 4 (Examples 1, 2, and 3) (FIGS. 14, 15).

Each of the Examples differs from the Comparative Examples in that MgO particles formed by precursor baking are mixed with the phosphor component. Thus, the phosphors are not only excited by the ultraviolet rays produced in the discharge gas, but also by the ultraviolet rays from the MgO particles, causing them to emit visible light efficiently and making it possible to emit light at a high luminance. In each of the Examples, the visible light that is produced by the phosphors is reflected well towards the front panel by the MgO particles, contributing to image display. This is considered to be another reason for superior luminance.

Note, however, that as the weight concentration of the MgO particles in the phosphor layer increases, the visible light that the MgO particles causes the phosphor particles to produce becomes increasingly blocked. Therefore, MgO particles should not be added to the phosphor layer by simply increasing their weight concentration to achieve the effect of increased luminance. Rather, the effect of blockage of visible light also needs to be considered, and a balance needs to be struck between these two effects to achieve maximum luminance.

The results described above for each experiment confirm the superiority of the present invention.

### <Other Remarks>

The PDP in the above Embodiments used MgO particles 16a-16d, but it is not necessary to use all of these four types of MgO particles simultaneously in the present invention. It suffices to use one or more of the following previously described MgO particles: 16a-16d, 16a1, 16a2, 16b1, 16b2, 16c1, 16d1.

### INDUSTRIAL APPLICABILITY

The PDP in the present invention is a gas discharge panel technology that can be used to drive a particularly high-resolution image display at low voltage. It can be used for television apparatuses, in display apparatuses for computers, etc. in means of transportation, public facilities, homes, and so forth.

As the present invention suppresses the occurrence of initializing bright points even in structures with a high Xe pressure or with very small cells, it can be used as a high image quality display, the image quality of which resists the effects of the temperature environment.

1. A plasma display panel having a first substrate and a second substrate that oppose each other with a discharge space therebetween and are sealed together around edge portions thereof, the first substrate including a phosphor layer in a surface region thereof facing the discharge space, wherein
the phosphor layer includes a phosphor component and MgO powder containing MgO particles that each have a crystal structure with a (100) crystal face and a (111) crystal face, and
the MgO powder is disposed at one or more of the following:
(i) inside the phosphor layer, (ii) on a surface of the phosphor layer facing the discharge space, or (iii) on a bottom of the phosphor layer facing a back side of the first substrate.

2. The plasma display panel in claim 1, wherein
a surface region of the second substrate facing the discharge space has MgO powder containing MgO particles with a. crystal structure identical to the crystal structure of the MgO particles in the phosphor layer.

3. The plasma display panel in claim 2, wherein
the surface region of the second substrate has a plurality of electrodes and a dielectric layer covering the plurality of electrodes, and
the MgO powder located in the surface region of the second substrate is disposed on a surface of the dielectric layer either directly or with a protective layer therebetween.

4. The plasma display panel in claim 1, wherein
the MgO particles have a hexahedral structure, with at least one truncated surface.

5. The plasma display panel in claim 4, wherein
a main surface of the MgO particles is the (100) crystal face, and the truncated surface is the (111) crystal face.

6. The plasma display panel in claim 1, wherein
the MgO particles have an octahedral structure, with at least one truncated surface.

7. The plasma display panel in claim 6, wherein
a main surface of the MgO particles is the (111) crystal face, and the truncated surface is the (100) crystal face.

8. The plasma display panel in claim 1, wherein
the MgO particles are tetrakaidecahedral, having 14 surfaces, of which six surfaces are the (100) crystal face, and eight surfaces are the (111) crystal face.

9. The plasma display panel in claim 8, wherein
a main surface of the MgO particles is the (100) crystal face, and a truncated surface is the (111) crystal face.

10. The plasma display panel in claim 8, wherein
a main surface of the MgO particles is the (111) crystal face, and a truncated surface is the (100) crystal face.

11. The plasma display panel in claim 1, wherein
the MgO particles are a product of MgO precursor baking.

12. The plasma display panel in claim 1, wherein
the MgO particles have a diameter of 300 nm or greater.

13. The plasma display panel in claim 1, wherein
the MgO particles have a BET value of 2.0 m²/g or smaller.

14. A plasma display panel having a first substrate and a second substrate that oppose each other with a discharge space therebetween and are sealed together around edge portions thereof, the first substrate including a phosphor layer in a surface region thereof facing the discharge space, wherein
the phosphor layer includes a phosphor component and MgO powder containing MgO particles that each have a crystal structure with a (100) crystal face, a (110) crystal face, and a (111) crystal face, and
the MgO powder is disposed at one or more of the following: (i) inside the phosphor layer, (ii) on a surface of the phosphor layer facing the discharge space, or (iii) on a bottom of the phosphor layer facing a back side of the first substrate.

15. The plasma display panel in claim 14, wherein
a surface region of the second substrate facing the discharge space has MgO powder containing MgO particles with a crystal structure identical to the crystal structure of the MgO particles in the phosphor layer.

16. The plasma display panel in claim 15, wherein
the surface region of the second substrate has a plurality of electrodes and a dielectric layer covering the plurality of electrodes, and
the MgO powder located in the surface region of the second substrate is disposed on a surface of the dielectric layer either directly or with a protective layer therebetween.

17. The plasma display panel in claim 14, wherein
the MgO particles have a hexahedral structure, with at least one truncated surface and at least one oblique surface.

18. The plasma display panel in claim 17, wherein
a main surface of the MgO particles is the (100) crystal face, the truncated surface is the (111) crystal face, and the oblique surface is the (100) crystal face.

19. The plasma display panel in claim 14, wherein
the MgO particles have an octahedral structure, with at least one truncated surface and at least one oblique surface.

20. The plasma display panel in claim 19, wherein
a main surface of the MgO particles is the (111) crystal face, the truncated surface is the (100) crystal face, and the oblique surface is the (110) crystal face.

21. The plasma display panel in claim 14, wherein
the MgO particles are hexaicosahedral, having 26 surfaces, of which six surfaces are the (100) crystal face, 12 surfaces are the (110) crystal face, and eight surfaces are the (111) crystal face.

22. The plasma display panel in claim 21, wherein
a main surface of the MgO particles is the (111) crystal face, an oblique surface is the (110) crystal face, and a truncated surface is the (100) crystal face.

23. The plasma display panel in claim 21, wherein
a main surface of the MgO particles is the (100) crystal face, an oblique surface is the (110) crystal face, and a truncated surface is the (111) crystal face.

24. The plasma display panel in claim 14, wherein
the MgO particles are a product of MgO precursor baking.

25. The plasma display panel in claim 14, wherein
the MgO particles have a diameter of 300 nm or greater.

26. The plasma display panel in claim 14, wherein
the MgO particles have a BET value of 2.0 m²/9 or smaller.
